(19) United States
(12) Patent Application Publication
(10) Pub. No.: US 2019/0045158 A1
(43) Pub. Date: Feb. 7, 2019

(54) IMAGING SYSTEM, IMAGING DEVICE, AND IMAGING METHOD

(71) Applicant: Olympus Corporation, Tokyo (JP)

(72) Inventors: Yoji Osanai, Tokyo (JP); Takeshi Nomiyama, Tokyo (JP); Kenichi Morishima, Sagamihara-shi (JP); Kazuhiko Osa, Tokyo (JP); Osamu NONAKA, Sagamihara-shi (JP)

(21) Appl. No.: 16/053,738

(22) Filed: Aug. 2, 2018

(30) Foreign Application Priority Data
Aug. 4, 2017 (JP) 2017-151775

(51) Int. Cl. H04N 7/18; G06T 7/70; H04N 1/21; H04N 1/00

(52) U.S. Cl. CPC H04N 7/185; G06T 7/70; H04N 2201/0084; H04N 1/00209; H04N 1/2112

(57) ABSTRACT

An imaging system for shooting and storing a plurality of processes that are performed using fingers of both hands, and eyes, comprising a control processor that detects the processes based on taken images that correspond to finger tip positions of either the left or right hand of a worker, from positions corresponding to the eyes of the worker performing the process, and a memory that stores taken images, and taken images in association with the processes, wherein the control processor 1) detects which of the left or right hand of the operator is being used in the process, 2) determines a first used tool or material to be used that is used by the detected hand, 3) detects operation start time in accordance with detection results for the first used tool or material, and 4) reasons the taken images corresponding to the start time by analogy.

### CROSS-REFERENCE TO RELATED APPLICATIONS

Benefit is claimed, under 35 U.S.C. § 119, to the filing date of prior Japanese Patent Application No. 2017-151775 filed on Aug. 4, 2017. This application is expressly incorporated herein by reference. The scope of the present invention is not limited to any requirements of the specific embodiments described in the application.

### BACKGROUND OF THE INVENTION

### 1. Field of the Invention

The present invention relates to an imaging system, imaging device and imaging method suitable for shooting and storage of a work process, when a craftsman (technician etc.) who performs work utilizing good eyesight and fine movement and sense of touch with both hands, a delicate sense of touch and experience etc. performs concentrated work using specialized tools. If such work has additional gratuitous operations and processes, a degree of concentration for delicate work is lowered and work efficiency drops, and so there is a need for technology that imposes as small a burden as possible on a work person who is a worker.

### 2. Description of the Related Art

In recent years, due to the development of Information Technology it has become easy to gather a large amount of information. On the other hand, it has become less easy to gather useful information from within a large amount of information. A system has therefore been proposed that provides various information between a plurality of companies (refer, for example, to Japanese patent laid-open No. 2014-016922 (hereafter referred to as “patent publication 1”)).

A work process for performing work by handling specialized tools requires concentration and extremely high individual skills with hand to eye coordination. It is therefore only possible to pass on the knowledge of such a work process with accurate skills, and establish evidence, after appropriate storing and observing the work process using a system that does not affect the work itself. With this specification, work that requires a refined sensitivity, particularly visually and in terms of sense of touch, will be described, but the same applies to work that requires others of the five senses Also, for operations that require such a high degree of specialization, there has also been progress with standardization of work environment, and a proper operation cannot be performed with improper arrangement of tools to be used and materials in front of a craftsman at the time of manufacture of a product. Accordingly, information on this type of operating environment can be a valuable operating determination. This is because quick workability is required such that even for the same workplace, operations are often performed with tools for each operation being prepared and arranged in advance, and from the field of view of the operator a tool is rapidly confirmed and picked up, or returned rapidly to a given position. That is, this type of state is determined using taken images at the time of operation, and determination of the operation based on the environment determination is extremely effective. For example, an image of this pallet entering the field of view (due to that pallet being prepared in front of the operator, or the operator facing in these directions) constitutes evidence of the fact that that operation is for performing coloring processing.

### SUMMARY OF THE INVENTION

The present invention provides an imaging system, imaging device and imaging method suitable for performing appropriate storage and observation in accordance with working location and state of progress etc. without burdening the operator, at the time of sensitive work that is performed with concentration utilizing hands and eyes.

An imaging system of a first aspect of the present invention, that shoots and stores a plurality of processes accompanying sensitive work that is performed with concentration utilizing hands and eyes, comprises: a control processor that detects the processes based on taken images that correspond to finger tip positions of either the left or right hand of a worker, from positions corresponding to the eyes of the worker performing the process, and a memory that stores taken images, and taken images in association with the processes, wherein the control processor 1) detects which of the left or right hand of the operator is being used in the process, 2) determines a first used tool or material to be used that that is used by the detected hand, 3) detects operation start time in accordance with detection results for the first used tool or material, and 4) reasons the taken images corresponding to the start time by analogy.

An imaging device of a second aspect of the present invention comprises, an image sensor that shoots a plurality of processes for manufacturing a product, a control processor that detects location specific processes according to a portion of the product based on taken images that have been acquired by the image sensor, and associates the taken images and the location specific processes, and a communication circuit that transmits the taken images that have been subjected to association by the control processor to an external device, and receives taken images that have been retrieved by the external device.

An imaging method of a third aspect of the present invention, for shooting and storing a plurality of processes for manufacturing a product, comprises: detecting location specific processes according to a portion of the product based on taken images, and storing taken images that have been associated with the location specific processes.

An imaging method of a fourth aspect of the present invention comprises, shooting a plurality of processes for manufacturing a product, detecting location specific processes according to a portion of the product based on taken images, associating the taken images and the location specific processes, and transmitting the taken images that have been subjected to association to an external device, and receiving taken images that have been retrieved by the external device.

### BRIEF DESCRIPTION OF THE DRAWINGS

FIG. 1 is a block diagram showing an overview of a storage system of a first embodiment of the present invention.

FIG. 2 is a drawing showing cloisonne, as a product, in the first embodiment of the present invention.

FIG. 3 is a drawing showing appearance of coloring cloisonné ware on a base, in the first embodiment of the present invention.

FIG. 4 is a table showing stored items of a database of the storage system of the first embodiment of the present invention.

FIG. 5A to FIG. 5C are block diagrams mainly showing the electrical structure of a storage system of a second embodiment of the present invention.

FIG. 6 is tables showing stored items of a database of the storage system of the second embodiment of the present invention.

FIG. 7 is a drawing showing a usage method of the storage system of the second embodiment of the present invention.

FIG. 8A to FIG. 8C are drawings showing wearable sections of the storage system of the second embodiment of the present invention.

FIG. 9A to FIG. 9D are drawings showing a usage method of wearable sections of the storage system of the second embodiment of the present invention.

FIG. 10 is a drawing showing a work process in the storage system of the second embodiment of the present invention.

FIG. 11 is a flowchart showing operation of a designer side information terminal of the storage system of the second embodiment of the present invention.

FIG. 12 is a flowchart showing server operation in the storage system of the second embodiment of the present invention.

FIG. 13 is a flowchart showing operation of a craftsman side wearable terminal in the storage system of the second embodiment of the present invention.

FIG. 14 is a flowchart showing server operation in the storage system of the second embodiment of the present invention.

FIG. 15 is a flowchart showing a movie storage operation of the storage system of the second embodiment of the present invention.

FIG. 16 is a flowchart showing display operation in accordance with conditions, of the storage system of the second embodiment of the present invention.

FIG. 17A and FIG. 17B are drawings showing a usage state of a designer, in the storage system of the second embodiment of the present invention.

### DETAILED DESCRIPTION OF THE PREFERRED EMBODIMENTS

The present invention relates to a unit, device and method for observing and storing a working process when a craftsman etc. performs work handling specialized tools. Anything that is obtained by means of highly specialized work often involves one-off customized production, and requires a high degree of skill. This means that appropriate operations and techniques are required in accordance with processing location, processing progress etc. Since this is work requiring an extremely high individual level of skill, with the meaning of skill transfer also, and for confirmation of work quality, in order to ascertain a process of working, technology has been required that can appropriately observe the work, and record the work. Work by a person of a high degree of professionalism or artisan skills, such as craftsman etc. needs such recording.

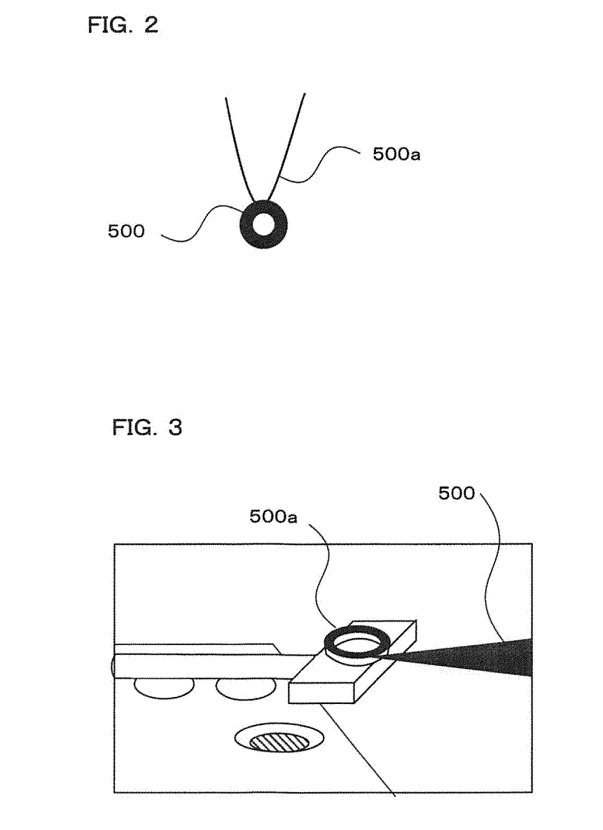

In particular, movement etc. of a person when manufacturing a cloisonné necklace such as shown in FIG. 2 that will be described later in this embodiment using tools such as a spatula etc. such as shown in FIG. 3, is analog movement, and therefore, rather than presenting characters, speech and still images etc. if a movie is reproduced there is a possibility of quickly and immediately understanding, since, as the saying goes, a picture is worth a thousand words. Therefore, as will be described in the following, a scheme is desired such that it is possible to reproduce only essential parts of work by dividing a movie up. Also, swift movements etc. can be observed in slow motion, and this can also be achieved with only a movie, which is another advantage of movie. In making a movie easy to retrieve, there is a desire to subdivide a process. In this way, there is a demand for technology to clearly visualize work, and make retrieval easy, and in the following description will be given for features of the present invention as respective embodiments.

In this way, an imaging system is desired such that a series of operations is shot by dividing into time frames as a plurality of different processes in order to record each process. If this imaging system has a process detection system that detects processes based on taken images, time division as described above becomes possible based on process detection results at the same time as shooting, and it is possible to store movie shooting images that have the taken images and the processes associated. As a result, with this imaging system only movies for sections that it is desired to observe later are retrieved, and playback of these sections becomes easy, which is useful in skill transfer. Obviously a storage control section within the imaging system may store part of a movie that has been continuously taken with titles of separate operations attached to each movie, so as to make it easy to retrieve for every operation, and it may also be possible to store in a file format that has metadata for separate operations attached.

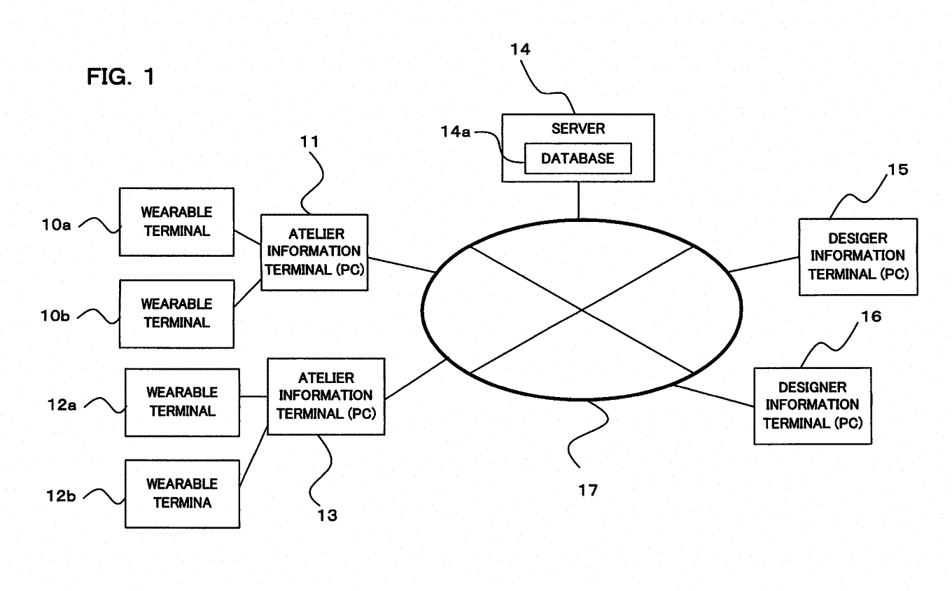

FIG. 1 is a block diagram showing an outline of overall structure of a first embodiment. This first embodiment is an example of a system with which it has been made easy to realize business development to a remote location. It is obviously also possible to integrate functions in only a partial structure, depending on the scale of the business.

In FIG. 1, atelier information terminals 11 and 13 are information terminals that are owned by an atelier to which a craftsman belongs, and are, for example, PCs (personal computers) capable of connecting to a network 17. It should be noted that in FIG. 1, atelier information terminals are shown at only two locations, but this is only an example, and there may be only one atelier information terminal, or three or more.

Wearable terminals 10a and 10b are terminals that are worn by individual craftsmen belonging to an atelier of the atelier information terminal 11. Similarly, wearable terminals 12a and 12b are terminals that are worn by individual craftsmen belonging to an atelier of the atelier information terminal 13. Image input sections for inputting images in the direction of the perspective of a craftsman, and/or sound input sections for inputting sound, for example, are provided in the wearable terminals 10a, 10b, 12a and 12b, and there is also a control section or the like for performing control within the wearable terminals. It should be noted that although only two wearable terminals have been shown in FIG. 1, this is merely an example, and there may be only a single wearable terminal, or there may be three or more. Also, in FIG. 1 the wearable terminals are connected by means of atelier information terminals, but they may also be connected directly to the network 17 without using the atelier information terminals 11 and 13.

The designer information terminals 15 and 16 are information terminals that are used by a designer, and are, for example, PCs (personal computers) capable of connecting to a network 17. Designers can retrieve an example of a desired product such as an accessory (jewelry)from within examples of products such as an accessory (jewelry)that have been manufactured by craftsmen, and can also place an order by means of the delivery agent information terminals 15 and 16. It should be noted that in FIG. 1, designer information terminals are shown at only two locations, but this is only an example, and there maybe only one designer information terminal, or three or more.

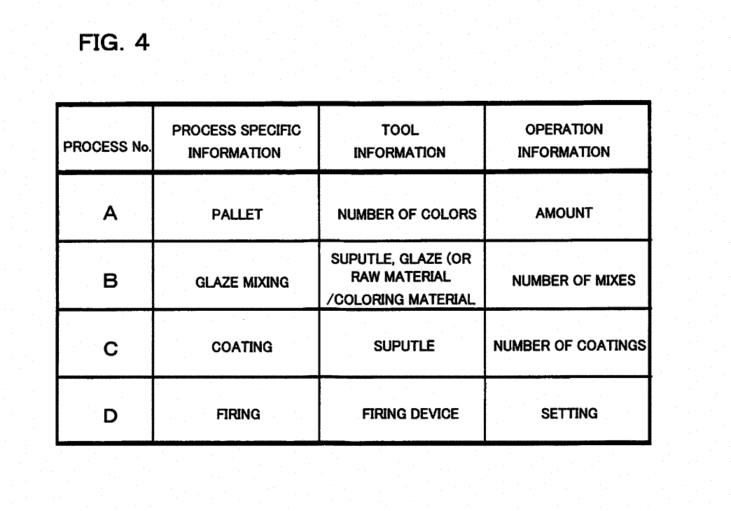

The server 14 is configured to be capable of communication with each unit via the network 17. The server 14 stores taken images of accessories, that have been received from the wearable terminals 10a, 10b, 12a, and 12b via the network 17, and information associated with these taken images, in a database 14a. Also, if a retrieval request relating to an accessory is received from the delivery agent information terminals 15 and 16, the server 14 searches the database 14a and transmits search results to the delivery agent information terminals 15 and 16. Information that is stored in the database 14a will be described later using FIG. 4.

The network 17 is a communication network such as the Internet, an intranet a telephone, and connects the atelier information terminals 11 and 13, the delivery agent information terminals 15 and 16, and the server 14 so as to be capable of communication. The network 17 may use wired communication or may use wireless communication.

Next, using FIG. 4, description will be given of the information that is stored in the database 14a of the server 14. With this embodiment, which kind of tool is used for each process, and what kind of operation is carried out, is stored in the database 14a. At the time of the craftsman performing operations, items stored in the database 14a may store specific content in association with taken images. In particular, with processes requiring a delicate and heightened sense, very often the operator will perform operations looking intently at tools that are being gripped by the fingers of both hands, and the object being worked on, and it is preferable to determine operations by detecting what state respective fingers are in.

Process No. A relates to pallet information for determining whether preparation of glaze (or raw material/coloring material), which is a material that is arranged first, is correct. Pallet information is information for a process of preparing the pallet (refer to S31 in FIG. 3). If glaze (or raw material/coloring material) preparation is wrong, it will not be possible to perform correct operations in the first place, and so a process for confirming completion of preparation before operations should be performed separately. The shape of a pallet has image characteristics of many repetitions, and is easy to detect, and it is therefore specially described for this reason. In this pallet process, what color glaze (or raw material/coloring material) is used with the pallet is stored as tool information, and amount of glaze (or raw material/coloring material) being a correct amount at the time of mixing glaze (or raw material/coloring material) on the pallet is stored as operation information. It is confirmed that correct items are correctly arranged, and that correct amounts have been prepared. Obviously, since items to be prepared are also types of tool, a dictionary may also be made that associates images and tool names, so as to be able to determine these items also using image recognition. Which of the left or right hand these tools are being held in etc. can also be a basis for determining an operation process. Also, since the way in which the tools are held etc. also differs depending on the tool it is preferable to determine with a degree of accuracy that can discern the shape of the fingertips.

Also, for operations that require such a high degree of specialization, there has also been progress with standardization of work environment, and a proper operation cannot be performed with improper arrangement of tools to be used and materials in front of a craftsman at the time of manufacture of a product. Accordingly, information on operating environment can be a valuable operating determination. This is because quick workability is required such that even for the same workplace, operations are often performed with tools for each operation being prepared and arranged in advance, and from the field of view of the operator a tool is rapidly confirmed and picked up, or returned rapidly to a given position. That is, this type of state is determined using taken images at the time of operation, and determination of the operation based on the environment determination is extremely effective. For example, an image of this pallet entering the field of view (due to that pallet being prepared in front of the operator, or the operator facing in these directions) constitutes evidence of the fact that that operation performs coloring processing.

Process No. B is glaze (or raw material/coloring material) mixing information, and this information is information for a process of mixing glaze (or raw material/coloring material) for the pallet (refer to S31 in FIG. 3). In this glaze (or raw material/coloring material) mixing process, tool information is a spatula and a glaze (or raw material/coloring material), and specifically, a type of spatula and a type of glaze (or raw material/coloring material) at the time of mixing are stored. Also, operation information is a mixed number, and more specifically what color and amount of each color being mixed are stored. With this type of analog operation, it is often the case that it is not possible to see or know that the usage of the spatula is wrong etc., and storage of such information as images is preferable.

Process No. C is coating process information, and this information is information for coating glaze (or raw material/coloring material) that has been mixed on the pallet on the mold of an accessory such as cloisonné ware (refer to S33 in FIG. 3). In this coating process, tool information is a spatula, and specifically is a type of spatula used at the time of coating, and as operation information a number of times coating is performed, more specifically, how many sub-coatings the coating process will subdivided into, is stored.

Process No. D is firing process information, and this information is information for firing, in a firing device, after having completed coating (refer to S39 in FIG. 3). In this firing process, tool information is the firing device, and more specifically is a maker name and model name, and as operation information settings, more specifically, elapsed time and firing temperature at that time, etc. are stored.

These databases describe tools and check items specific for that operation, and so the content inserted here is detected. Since content can be determined using images, images are determined, retrieved and referenced using this content. In process A, whether a pallet that has been arranged is a standard pallet, whether or not there are a number of colors provided, etc. can be determined using images. This can be determined by comparing with specified reference images. Also, amounts etc. can also be determined from images. In process B, regarding glaze (or raw material/coloring material) mixing etc., spatula control by the craftsman etc. is very important, and coating is subdivided so that it will be easy to reference operations at this time later. It is easy to determine distinctive tools and movement that is specific to a mixing operation (tip of a spatula being at a pallet portion etc.) using images. If this type of detection method can also be stored in a database, retrieval is easy. Similarly, coating can be searched using image determination, such as the tip of a spatula being close to a base or the other hand. This type of database is not only capable of simply comparing with simple dictionary images, but is also capable of handling improved performance and divergence with deep learning where a large number of training images are learned. It goes without saying that this type of approach is also common to other practical examples.

As has been described above, in the first embodiment of the present invention, information that is used at the time of accessory manufacture is stored in the database 14a. Various information when the craftsman manufactures the product such as an accessory (jewelry) is therefore stored in the database 14a. Information at the time of manufacture that has been stored may be utilized when another craftsman manufactures a similar accessory. Generally, it is desired to keep evidence that is broken down for each process. As evidence there are materials that have been input by handwriting or keyboard, such as progress schedule for operations, checklists, and inspection results that are received, delivery inspection results, operator and date etc. and it is also possible to use information that complements that. For example, as evidence in this embodiment there are images that have been acquired by an image input section that has been arranged within a wearable terminal and/or an atelier, and speech etc. of a craftsman or the like that has been acquired by a speech input section. Then, using these items of evidence, it is possible to perform isolation for each process without imposing a burden on the operator, and isolation determination may be performed in accordance with characteristics of the respective processes. If information, such as image data that has been isolated for each process, is stored in a format that is also easy to confirm (for example, an image file with metadata), it is possible to retrieve only these crucial parts, and to easily confirm under various conditions.

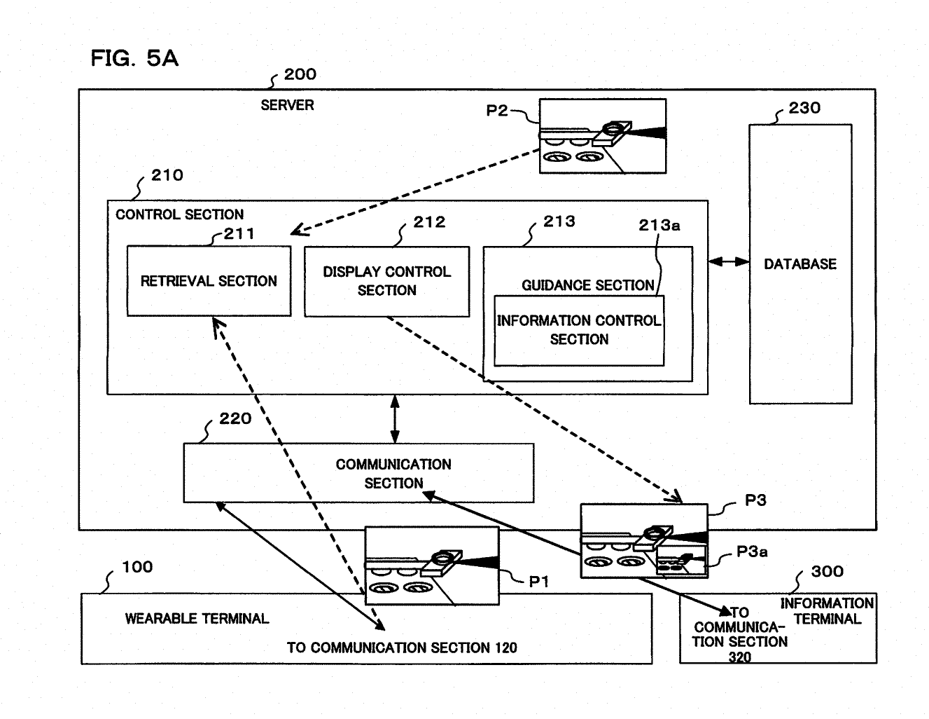

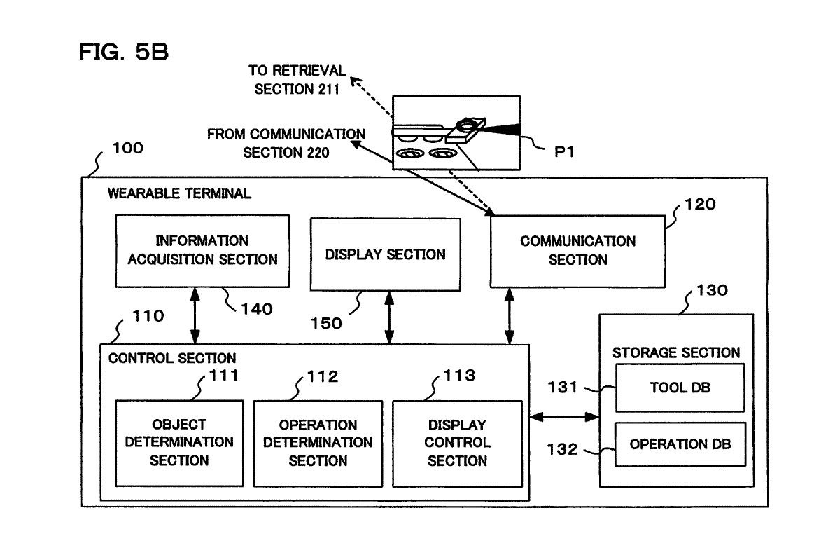

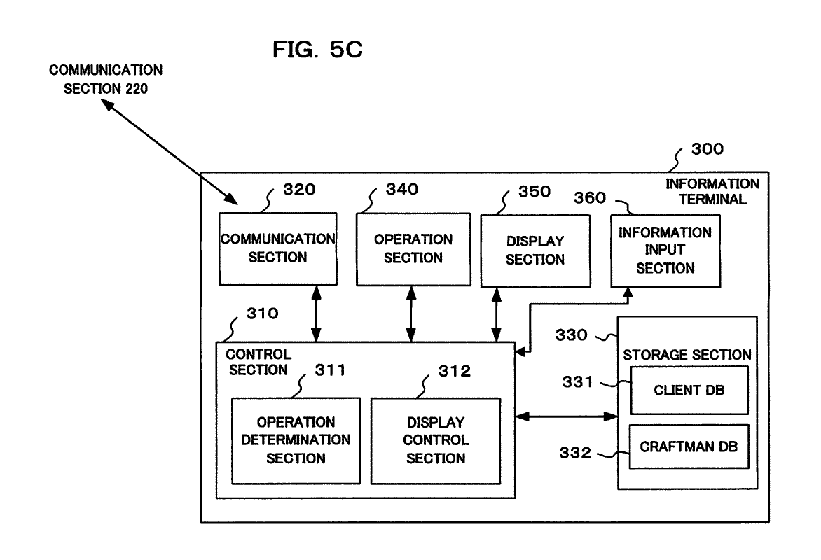

Next, a second embodiment of the present invention will be described using FIG. 5A to FIG. 17B. For parts that have been described in the first embodiment duplication will be avoided, but corresponding portions perform similar operations, and methods of determination may also use similar technology. FIG. 5A to FIG. 5C are block diagrams mainly showing the electrical structure of this embodiment. The system of this embodiment can shoot and store a plurality of processes for manufacturing a product that are performed using the fingertips of both hands, and eyes. This system has a wearable terminal 100, a server 200 and an information terminal 300. In FIG. 5A to FIG. 5C, there are only a single wearable terminal 100, server 200 and information terminal 300 respectively, but a plurality of these devices can be connected by means of a network etc. With this system, the wearable terminal 100 is a glasses-type terminal, and it is possible to understand the relationship between position of both hands at the time of an operation, and position of a tool and material associated with this operation. It should be noted that FIG. 5A shows the overall electrical structure of the second embodiment, FIG. 5B shows the detailed structure of the wearable terminal 100, and FIG. 5C shows the detailed structure of the information terminal 300.

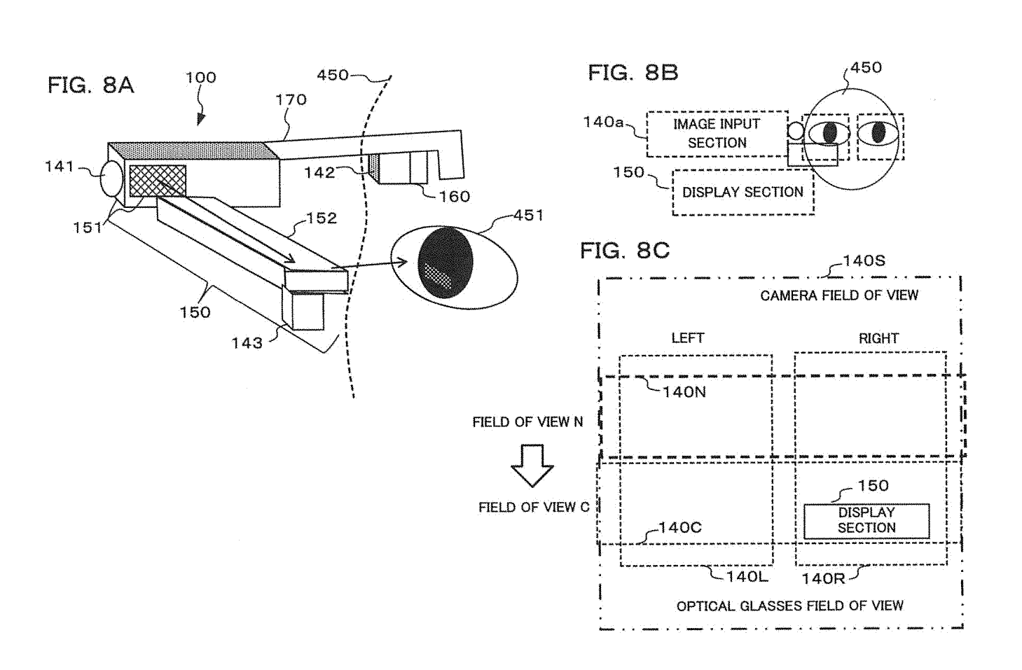

As shown in FIG. 5B, the wearable terminal 100 has a control section 110, communication section 120, storage section 130, information acquisition section 140, and display section 150. The wearable terminal 100 is in the form of a pair of glasses, which a craftsman wears, and as well as acquiring images of a product such as an accessory (jewelry) or the like, it is possible to display guidance information at the time of manufacture of a product such as an accessory (jewelry). The form of the wearable terminal 100 will be described later using FIG. 8A. One advantage of being in the form of a pair of glasses is that in cases where it is assumed that many operations will be visually checked by an operator, it is possible to perform image confirmation of a physical object from the same direction that the operator is looking in, with a camera (information acquisition section) built in to the glasses-type terminal. Obviously in cases such as a hammering test also, if a pair of glasses form is used it is possible to perform sound confirmation of the same sounds that the operator has heard, using a built in microphone (information acquisition section). In this way, it is possible to confirm isolation for each process in accordance with characteristics of respective processes, without imposing a load on the operator.

The control section 110 has a control processor, and this control processor is constituted by an ASIC (Application Specific Integrated Circuit) that has a CPU (Central Processing Unit), a memory that stores programs, and peripheral circuits. This control section 110 performs overall control by controlling each section within the wearable terminal 100. There are also a physical object determination section 111, an operation determination section 112, and a display control section 113 within the control section 110, and each of these sections is implemented by the CPU and a program in this embodiment. It should be noted that some or all of the sections may be implemented using peripheral circuits.

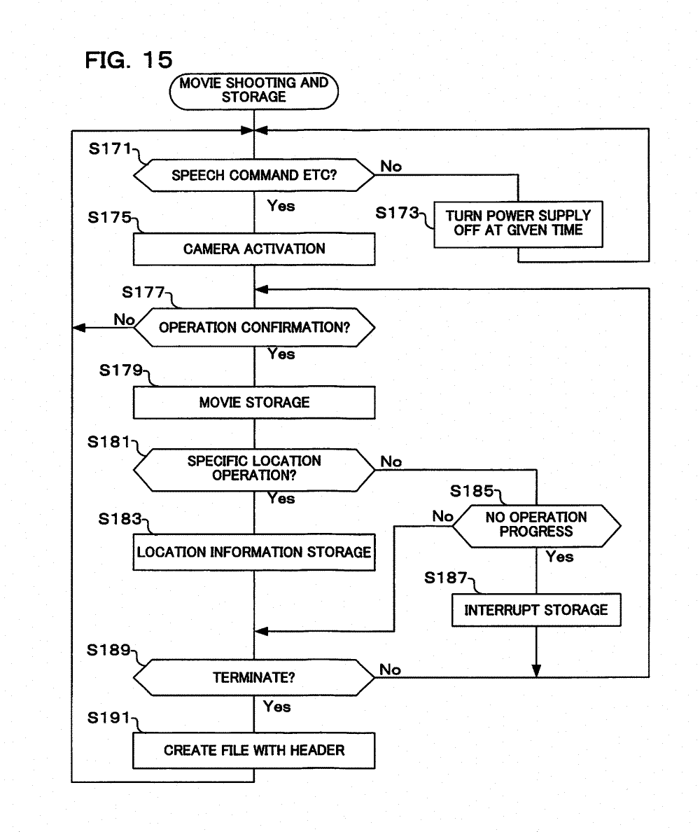

The physical object determination section 111 determines whether or not there is a physical object that a craftsman is working on based on image data that has been acquired by an image input section 140a within the information acquisition section 140, which will be described later. Also, in a case where the physical object is a product such as an accessory (jewelry), it is also determined where sections that are to be worked on are (refer, for example, to S181 in FIG. 15).

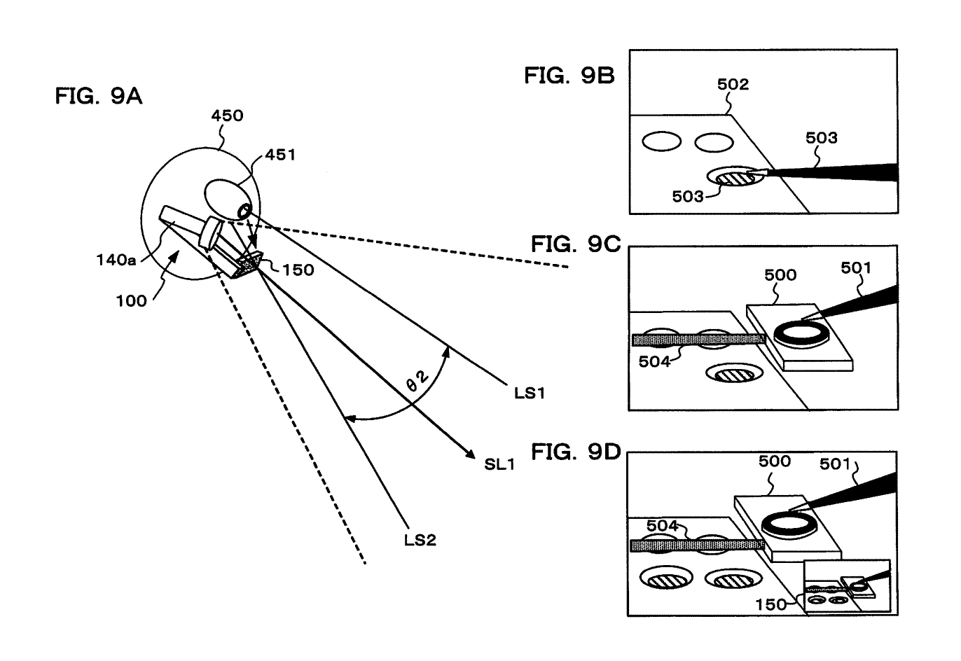

The physical object determination section 111 functions as a control processor (location specific process detection section) that detects location specific processes in accordance with a portion of the product based on taken images corresponding to fingertip positions of either the left or right hand of the operator from position corresponding to the eyes of an operator performing the process. The physical object determination section 111 also functions as a control processor (process detection section) that detects start time of a given process, from a plurality of processes, based on taken images (refer to S181 in FIG. 15). In portion determination, as shown in FIG. 9A to FIG. 9D which will be described later, it is possible to determine a portion where operations are performed from a positional relationship between a holding device 504 for holding a spatula 501, based on taken images. Specifically, the control processor (location specific process detection section) determines location of the product by image determination of a second used tool within taken images at the time of manufacture of the product. It is possible to determine location with positional relationship between a plurality of tools and fixtures. This means that it is also possible to determine which of left and right fingers are gripping a tool by position corresponding to direction in which finger tips extend (in this case, since the operator is looking with a fixed gaze, a glasses-type terminal is effective).

The operation determination section 112 determines whether or not operation is in progress (refer, for example, to S177 in FIG. 15), and what the operational content being carried out by a craftsman is, based on image data that has been acquired by an image input section within the information acquisition section 140. For example, a coating operation for glaze (or raw material/coloring material) material etc., and a firing operation etc. are determined.

The display control section 113 may also have a display control circuit that performs control of images displayed on the display section 150, which will be described later. As image display there is guidance display etc. in accordance with a portion a craftsman is working on.

The control section 110 associates information relating to a portion that has been detected by the physical object determination section 111 (location specific process detection section) with taken images that have been acquired by the image input section 140a of the information acquisition section 140 (refer, for example, to S179, S181 and S183 in FIG. 15). Taken images for which this association has been performed are stored in a database 230 within the server 200, by means of the communication section 120. The control section 110 functions as a control processor for taken images and location specific processes (association section that performs association). The control processor determines operation due to having the data as shown in FIG. 4 stored in a database.

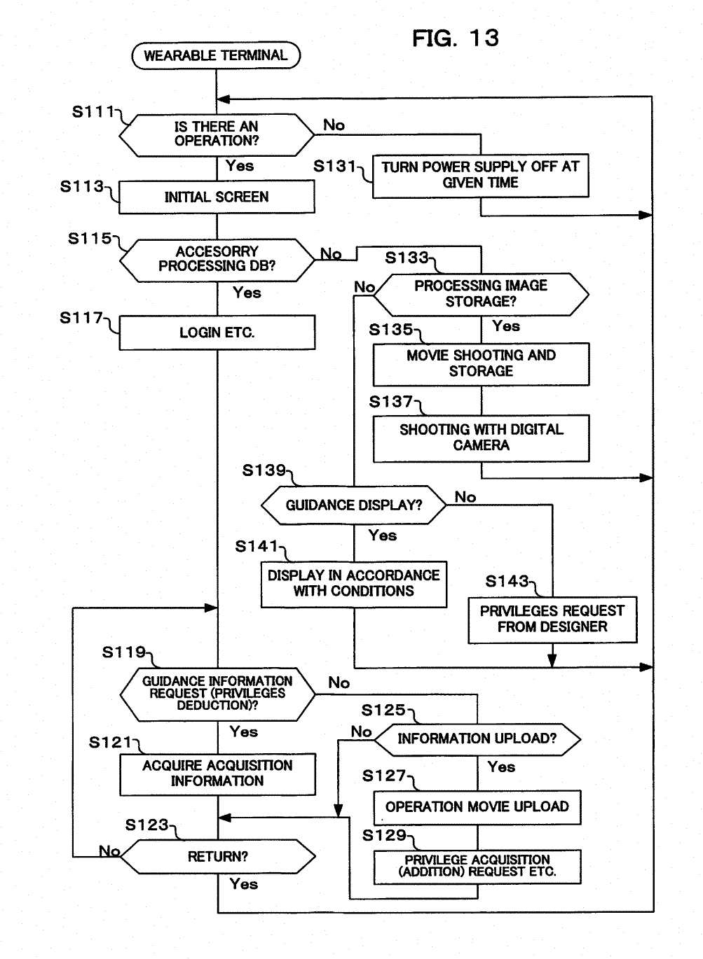

The communication section 120 has a communication circuit, and performs communication such as for data and control commands with the server 200. The communication section 120 functions as a communication circuit for transmitting taken images that have been subjected to association by the control processor (association section) to an external device, and receiving taken images that have been retrieved in the external device (refer to S127 and S141 in FIG. 13). This communication circuit transmits information relating to location that has been detected by the control processor (location specific process detection section) to an external device, and receives taken images associated with location that have been retrieved in the external device.

The storage section 130 has an electrically rewritable non-volatile memory, and stores various data of the wearable terminal 100. Within the storage section 130 there are regions for a tool database (DB) 131, and an operation database (DB) 132. The storage section 130 functions as a memory for storing taken images by associating with location specific processes. The storage section 130 also functions as a memory for storing taken images corresponding to start timing of an operation, by associating taken images and processes. It should be noted that this memory is not limited to the wearable terminal, and may also be provided within the server 200.

The tool DB 131 is a region for storing data relating to tools that are used when the craftsman is working. Tools are spatulas and pallets etc., for example. The operation DB 132 is a region for storing data relating to operations that are performed by a craftsman. As operations there are, for example, a glaze (or raw material/coloring material) mixing operation, a glaze (or raw material/coloring material) coating operation, firing operation etc. It should be noted that at least one of the tool DB 131 and the operation DB 132 may be stored in a database 230 within the server 200. S

The information acquisition section 140 has the image input section 140a and a sound acquisition section 143 etc., and acquires information relating to a craftsman who is wearing the wearable section 100. The image input section 140a (refer to FIG. 8B) has an image sensor, and has an optical lens for image forming and an imaging circuit, and acquires image data for locations where the craftsman is performing work. Also, the sound acquisition section 143 (refer to FIG. 8) has a microphone, sound signal processing circuit etc., and acquires surrounding sound data when the craftsman is performing work. The image sensor within the image input section 140a functions as an image sensor for shooting a plurality of processes for manufacturing a product.

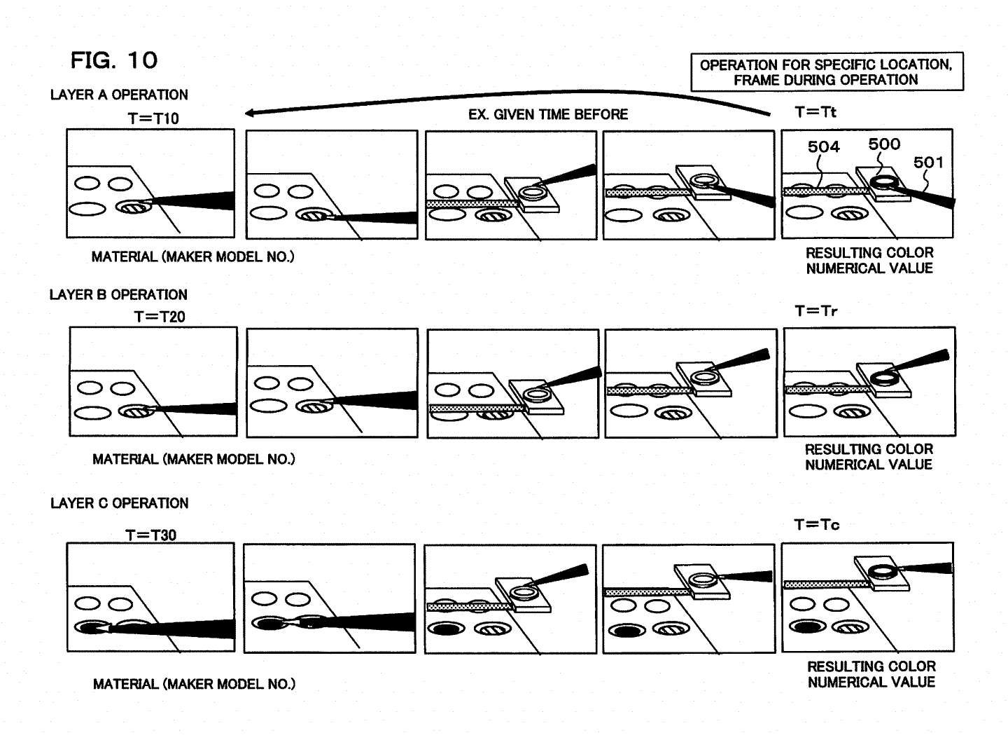

The display section 150 has a display for displaying operation guidance etc. to the craftsman. As will be described later using FIG. 8A, with this embodiment the wearable terminal 100 is a glasses type terminal, and when worn by a craftsman display of operation guidance etc. is performed at the side of one eye, superimposed on a scene in front. The display section 150 functions as a display that displays taken images. This display determines an operation start frame from the taken images by analogical inference, and display commences from this work start point (refer to FIG. 10). Also, display is display of taken images that have been retrieved by the external device (refer, for example, to S141 in FIG. 13), when retrieval of taken images for specified portions has been requested to the external device (refer, for example, to S119 in FIG. 13).

The server 200 controls the overall system of this embodiment, and as well as being accessible from the wearable terminal 100 and information terminal 300, the wearable terminal 100 and the information terminal 300 are also accessible from the server 200. Specifically, images and information transmitted from the wearable terminal 100 are stored in the database 230, and information relating to operational guidance requested from the wearable terminal 100 is transmitted. Information relating to a product such as an accessory (jewelry) requested from the information terminal 300 used by the designer is also transmitted. Besides this, various information is received and transmitted.

The control section 210 within the server 200 has a second control processor, and is constituted by an ASIC (Application Specific Integrated Circuit) having a CPU (Central Processing Unit), a memory that stores programs, and peripheral circuits. This control section 210 performs overall control within server 200, and also performs overall control of data and information etc. for the wearable terminal 100 and the information terminal 300.

There are also a retrieval section 211, display control section 212 and guidance section 213 inside the control section 210, and each of these sections is implemented by the CPU and a program in this embodiment. It should be noted that some or all of the sections may be implemented using peripheral circuits.

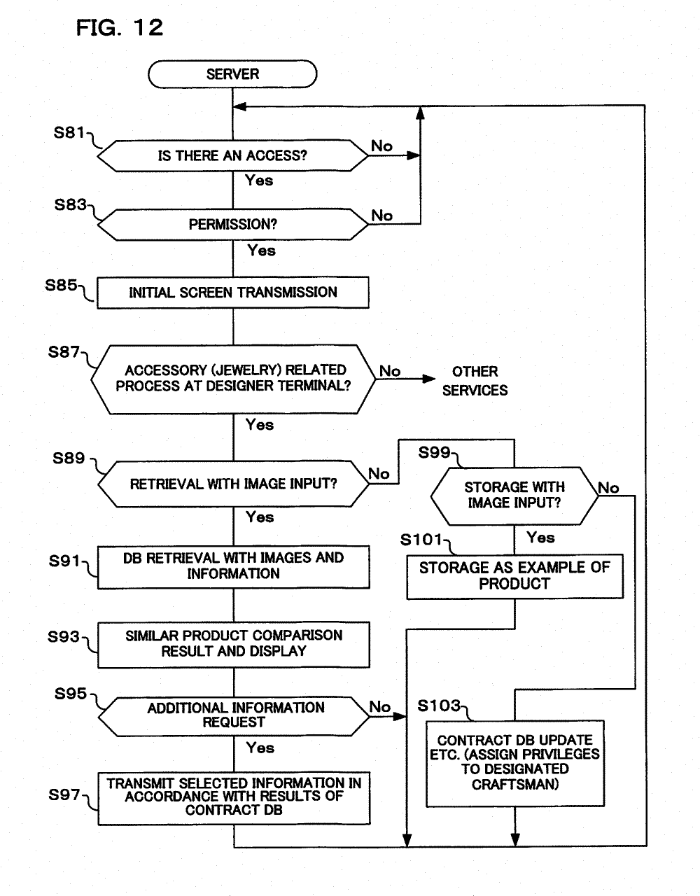

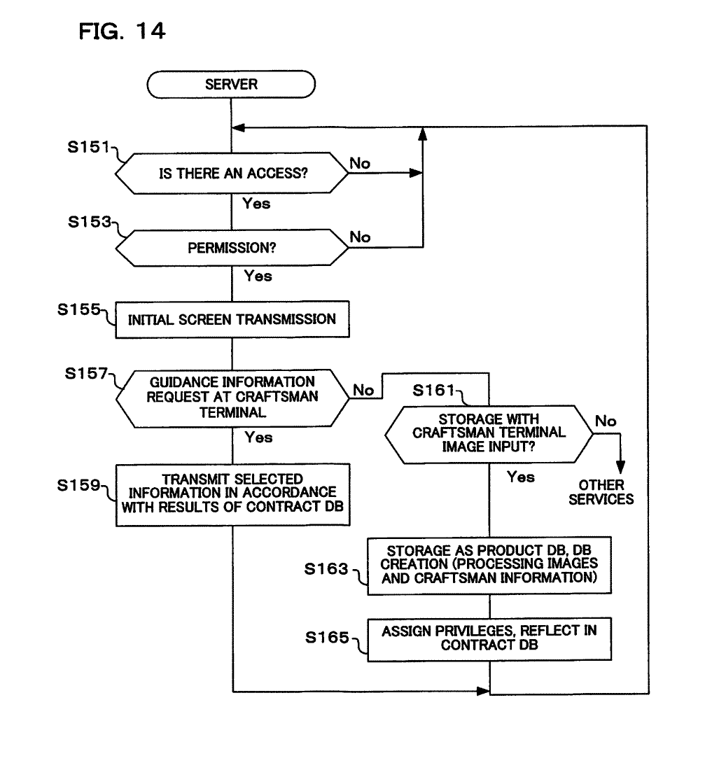

The retrieval section 211 retrieves information in accordance with requests from the wearable terminal 100 and the information terminal 300. For example, in the event that there has been a request for guidance information relating to operation locations from the wearable terminal 100 worn by a craftsman, information corresponding to this request is retrieved from the database 230 (refer, for example, to S159 in FIG. 14). Also, in the event that there has been a request relating to a craftsman who is capable of manufacturing a product such as an accessory (jewelry) in conformity with a client's demands from the information terminal 300 used by the designer, an example that is close to this product such as an accessory (jewelry) is retrieved from the database 230 (refer, for example, to S91 and S97 in FIG. 12).

For example, if operating image P1 has been transmitted from the wearable terminal 100 by means of the communication section 120, as shown in FIG. 5A, then the retrieval section 211 retrieves operating image P2, in which the same operation is being performed at the same location, from the database 230 using this operating image Pl. Also, the retrieval section 211 acquires taken images, a simulation image, or a target image from the information terminal 300, and retrieves images that are similar to the same image that has been acquired from within the database 230.

The display control section 212 performs display control so that guidance information (which may also include text information) is correctly displayed on each display section 150 and 350, when information that has been retrieved by the retrieval section 211 is transmitted to the wearable terminal 100 or the information terminal 300. For example, if the retrieval section 211 retrieves image P2, image P3 having the guidance image P3a superimposed on the operation image P1 is generated and transmitted to the wearable terminal 100. The wearable terminal 100 displays this image P3 that has been received on the display section 150. Guidance information (text information) that is stored in association with the guidance image P3a may also be displayed in the image P3.

The guidance section 213 generates data for performing guidance display using the images that have been retrieved by the retrieval section 211. Also, the information regulation section 213a performs information regulation for a disclosure range. Specifically, range for information disclosure is regulated in accordance with a contract DB 232, as will be described later, and the information regulation section 213a performs information disclosure pursuant to this contract (refer, for example, to S159 in FIG. 14).

Also, in a case where guidance display has been requested for a given portion from the wearable terminal 100, as will be described later using FIG. 10, the guidance section 213 determines a frame of an image from a start point, such as a given time before operation for this specified portion commences, by analogical reasoning. It should be noted that the start point is not limited to a given time before, and in cases where there is a positional relationship with a tool (e.g., with respect to the field of view, with respect to the workpiece, with respect to a second tool, and/or with respect to raw materials) that is used etc., analogical reasoning may be based on other items. The guidance section 213 functions as a control processor (start point image analogical reasoning section) that uses analogical reasoning to determining a frame of the taken images corresponding to a work start point, based on a first used tool or tool combination, a position being worked on the workpiece, and/or a raw material used in a process corresponding to a portion (also referred to as a “sub-process,” or “step” of the process), and/or a position of a tool, a workpiece, and/or a raw material with respect to the field of view, another tool, or another one of the tool, workpiece, or raw material. Note that a tool may be identified by one or more of its shape, color, relative size, sound (e.g., in the case of a power tool), etc. Similarly, a raw material or a workpiece may be identified by one or more of its shape, color, relative size, etc. It should be noted that in this embodiment, the control processor (start point image analogical reasoning section) is provided within the server 200. However, taken images transmitted from the server 200 may be analyzed by the wearable terminal 100, to determine the start point image by analogical reasoning. In this case, the control processor provided within the wearable terminal may also serve as a control processor. Also, as was described previously, the physical object determination section 111 provides a function as a control processor for detecting location specific processes corresponding to locations of the product based on taken images. Accordingly, the control processor is not limited to a processor that is physically integrated, and may perform distributed processing, and may have an integrated structure. A video image file may be provided with metadata (e.g., an index) indexing one or more start points (and possibly end points) of one or more steps or sub-processes of the process. Each index may specify a time stamp or frame of the video file.

Also, a movie commencement portion of guidance display is not necessarily the operation start point, and there is also a confirmation method so as to play a movie of the operation from a midpoint and then play back the earlier part. The start point image analogical reasoning section may therefore be called an index assigning section so as to determine where a played back image is in a movie. That is, this image is acquired in a field of view during operation that has been taken from close to the eyes of the operator, and a start point image analogical reasoning section (index assigning section) has a determination section for determining the appearance of operations with both hands of the operator, and fixtures tools and materials that have entered into the field of view during operation, and frames of taken images corresponding to a work start point and to a given time during operation are determined by analogical reasoning based on the fixtures, tools and materials that are used in the process. At this time, process specific required operation time, and process sequence etc. that are ordinary information as database information may be applied to process determination for improving accuracy of process determination, besides determination of each process by comparing image characteristics, such as tools and material, that have been stored in a database such as in FIG. 4 with taken images.

As shown in FIG. 5C, the information terminal 300 has a control section 310, communication section 320, storage section 330, operating section 340, and display section 350. The information terminal 300 is a terminal that is used by a designer, and craftsmen who are capable of making a product such as an accessory (jewelry) that is suitable for a client can be retrieved via this information terminal 300. Specifically, in making a product such as an accessory (jewelry), while it is necessary to have a color etc. that is extremely close to a color etc. desired by a client, because of personal taste and sensitivity demands it is preferable to locate craftsmen taking into consideration the craftsman's previous experience. With this embodiment therefore, images showing previous product such as an accessory (jewelry) manufacturing experience of a craftsman are stored in the database 230, and the designer locates the most suitable craftsman by displaying these images.

The control section 310 is a third control processor, and this processor is constituted by an ASIC (Application Specific Integrated Circuit) having a CPU (Central Processing Unit), a memory that stores programs, and peripheral circuits. This control section 310 performs overall control of the information terminal 300 by controlling each section within the information terminal 300. There are also an operation determination section 311 and a display control section 312 within the control section 310, and each of these sections is implemented by the CPU and a program in this embodiment. It should be noted that some or all of the sections may be implemented using peripheral circuits.

The operation determination section 311 has a determination circuit, and determines operating state of the operating section 340. For example, in the event that a keyboard is provided as the operating section 340, text information that has been input using the keyboard is determined. Similarly, in the event that a mouse has been provided as the operating section 340, movement of the mouse is determined

The display control section 312 also has a display control circuit, and performs control of images displayed on the display section 350. For example, in a case where an image relating to a product such as an accessory (jewelry) has been transmitted from the server 200, display control for this image is performed.

The communication section 320 has a communication circuit, and performs communication such as for data and control commands with the wearable terminal 100.

The storage section 330 has an electrically rewritable non-volatile memory, and stores various data of the information terminal 300. Within the storage section 330 there are regions for a client database (DB) 331, and a craftsman database (DB) 332. The client DB 331 is a region that stores data relating to client name, product such as an accessory (jewelry) to be worn, etc. The craftsman DB 332 is a region that stores data relating to craftsmen that have conducted transactions with the designer in question, or craftsmen who are transaction candidates.

The operating section 340 has an input interface, and has operation input members, such as a keyboard, mouse, or touch panel, provided in the information terminal 300. An information input section 360 inputs information of images and sounds etc. to the information terminal. The designer can input information such as shape and color in order to manufacture a product such as an accessory (jewelry) for the client, using the information input section 360.

The display section 350 is a display or the like provided on the information terminal 300, and displays images that have been transmitted from the server 200. Display of various menu screens etc. is also possible.

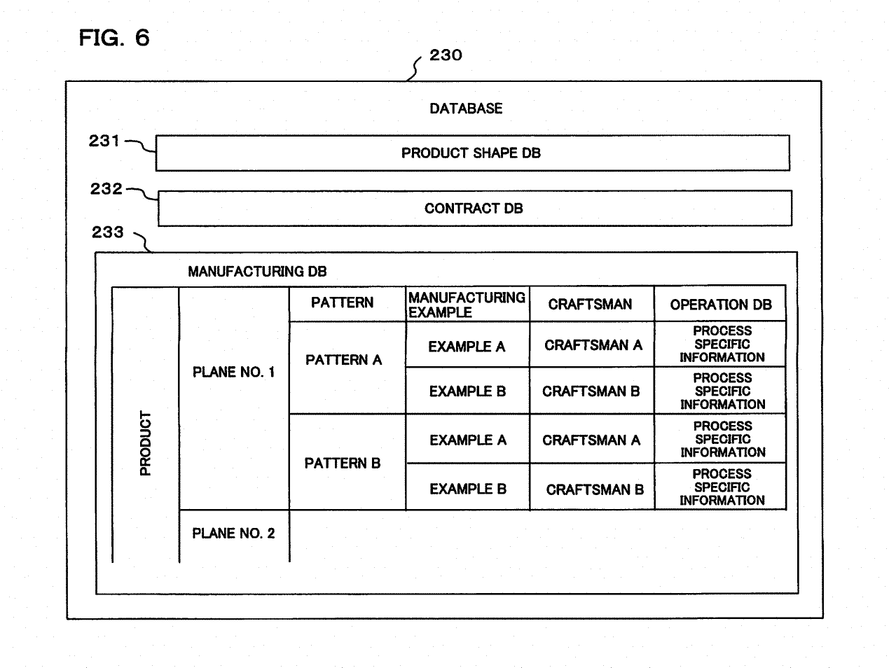

Next, data that is stored in this embodiment will be described using FIG. 6. FIG. 6 shows data that is stored in the database 230. In the database 230 there are regions for a product shaped database (DB) 231, a contract database (DB) 232, and a manufacturing database (DB) 233.

The product shape DB 231 is a database in which shapes of product and shape of a product such as an accessory (jewelry) are expressed three-dimensionally. When the designer retrieves craftsmen, it is possible to retrieve craftsmen who have manufactured product such as an accessory (jewelry) of similar shape using this product shape DB 231.

The contract DB 233 stores contracts relating to information acquisition between the craftsman and the designer. As was described previously, a range of information disclosure between the craftsman and the designer differs depending on a contract. For example, there may be cases where for craftsman A information that is transmitted to the server 200 using images that have been acquired using the wearable terminal 100 is not restricted, and can be disclosed to a third party, while for craftsman B the range of information that can be disclosed to a third party is restricted. There may also be cases where a range of information that can be disclosed to the craftsman side is also restricted. Therefore, with this embodiment, in order to restrict the disclosure range in accordance with these contracts, the contract DB 232 is provided.

The manufacturing DB 233 stores experience of the craftsman having manufactured products such as an accessory (jewelry). “plane 1” and “plane 2” represent plane positions. Respective product such as an accessory (jewelry) that have actually been manufactured are stored as example A and example B, and name of the craftsman who manufactured the respective examples, and operation information for the examples (operation DB), are stored as a database.

In the manufacturing DB 233, secrecy rises in the order of manufacturing example, craftsman name, and operation DB, and information management becomes important. A craftsman who sanctions disclosure of important information may also receive disclosure of highly secret information depending on privilege.

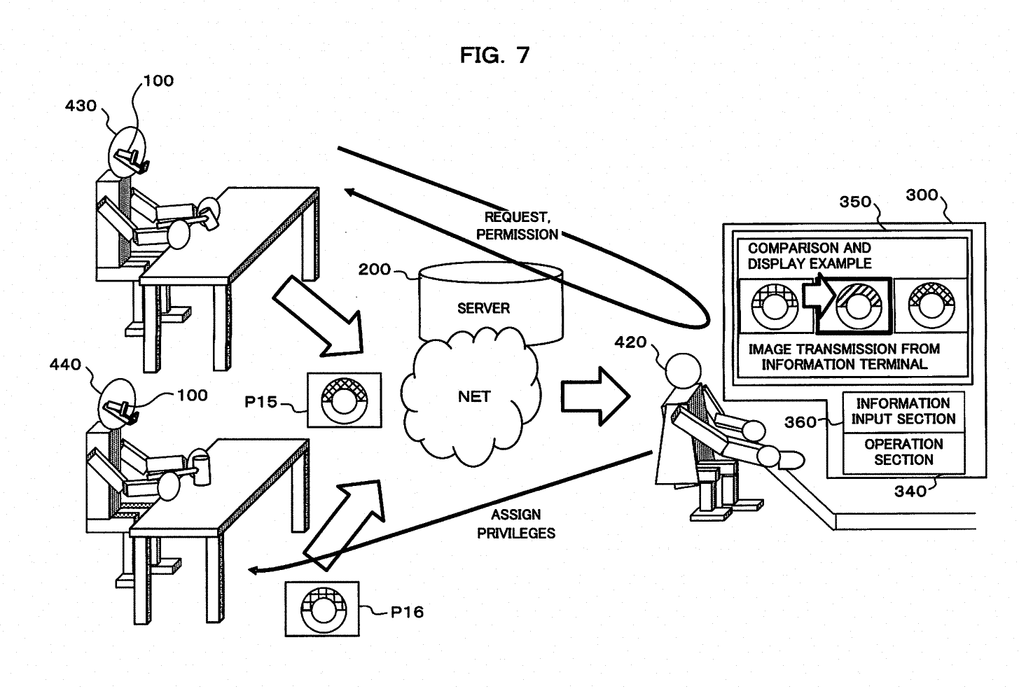

Next, guidance display at the time of craftsman selection and manufacture of a product such as an accessory (jewelry) will be described using FIG. 7.

The designer 420 shown on the right side of FIG. 7 is retrieving craftsmen (ateliers) to request manufacture of a product such as an accessory (jewelry) from, using the information terminal 300. Specifically, the designer 420 causes display of menu screens for selection of craftsmen to manufacture a product such as an accessory (jewelry) by operating the operating section 340. Then, images relating to shape and color of the product such as an accessory (jewelry) are input from the information input section 360, and other conditions etc. are input using the operating section 340.

Shape and color etc. of the product such as an accessory (jewelry)are displayed on the display section 350 of the information terminal 300, and this is transmitted to the server 200. The server 200 retrieves products such as an accessory (jewelry) that are close to an image that has been received from among images of product such as an accessory (jewelry) that were manufactured previously stored in the database 230, and returns the images of the product such as an accessory (jewelry) that have been retrieved to the information terminal 300. These retrieved images and images of products such as an accessory (jewelry) that have been transmitted from the information terminal 300 are displayed side-by-side on the display section 350 of FIG. 7 so that they can be easily compared.

The designer 420 can select a craftsman who is capable of manufacturing a product of a color etc. that is desired by the designer 420 or the client from among a plurality of images of products such as an accessory (jewelry) displayed on the display section 350. If a craftsman is determined, it is extremely convenient if a system is configured so that an order is placed to a craftsman via the information terminal 300 on the server 200.

A craftsman A430 and a craftsman B440 who manufacture product such as an accessory (jewelry) are shown on the left side of FIG. 7. The craftsman A430 and the craftsman B440 manufacture product such as an accessory (jewelry) wearing respective wearable terminals 100 on their heads. At the time of manufacture of a product such as an accessory (jewelry) by the craftsman A430, while a movie image P15 that has been taken by the image input section 140a of the wearable terminal 100 (refer to FIG. 8B) is stored in the database 230 within the server 200, similarly a movie image P16 during manufacture by the craftsman B440 is also stored in the database 230 within the server 200.

It should be noted that with the craftsman A430 manufacturing a product such as an accessory (jewelry), in a case where it is desired to receive guidance in a manufacturing method it is very useful if it is possible to browse movies for cases of applying the same processing to the same location. However, manufacturing methods are often business secrets. The craftsman A430 therefore applies for permission to browse using the server 200. The information regulation section 213a within the server 200 determined whether or not to allow the craftsman A430 to browse guide images in accordance with contractual content stored in the contract DB 232.

If permission is granted by the information regulation section 213a, the craftsman A430 can browse guidance images relating to the portion currently being manufactured, while performing operations, using the display section 150 of the wearable terminal 100 (refer to FIG. 8B). With the example shown in FIG. 7, the craftsman A430 browses operations that have been performed by the craftsman B440. In this case, some kind of benefit is given to the craftsman B440. As a benefit, it may be made possible to browse movies of operations that have been performed by the other craftsman, and monetary reward may be given etc.

Next, the wearable terminal 100 will be described using FIG. 8A to FIG. 8C. This wearable terminal 100 is shaped like a pair of glasses, and is worn on the head of the craftsman 450, as shown in FIG. 8B. The wearable terminal 100 is provided with an image input section 140a at a tip of a temple 170 (refer to FIG. 8A). With this type of device, for operations with both hands seen through the operator's eyes, it can be detected without obstruction which operations are being performed with which hand holding a working object and a work tool. Provided that fingertips can be detected, it is possible to detect the way of holding that tool etc.

Also, with this embodiment, lenses are not provided in the rims in which lenses would normally be arranged, and glass having no optical power or that is simply transparent is arranged. It should be noted that lenses may be arranged, in accordance with the eyes of the craftsman 450. The display section 150 is arranged in the rims so as to perform superimposed display.

FIG. 8A is a perspective drawing showing shape of the wearable terminal 100. The wearable terminal 100 is shaped like a pair of glasses, as was described previously, and has temples 170 and the display section 150. The display section 150 is arranged at a position of the rims of the glasses. An objective lens 141 is provided at a tip end of the temple 170, and an image sensor is arranged at a position inside the temple 170 where an image is formed by the objective lens 141. The image input section 140a is made up of the objective lens 141 and the image sensor.

A circuit housing section 142 is provided on the temple 170 of the wearable terminal 100, and this circuit housing section 142 houses circuits such as the control section 110, communication section 120 and storage section 130. Also, a sound and vibration output section 60 is provided close to the earpiece of the temple 170. The sound and vibration output section 60 performs guidance by emitting sounds and vibrations when performing guidance display images, or without images

A display panel 151 provided in the temple section 170, and an optical guiding section 152 for optically guiding images that have been displayed on this display panel 151 to the eyes 451 of the craftsman 450, are provided in the display section 150 of the wearable terminal 100. The craftsman 450 can see the guidance display (guidance information) via the optical guiding section 152. A sound input section 143 is also provided the display section 150. There is a microphone in the sound input section 143, and it is possible to collect sounds in the vicinity of the craftsman 450.

FIG. 8C is a drawing for explaining field of view the wearable terminal 100. The regions surrounded by the two-dot chain line 140S are field of view of the image input section 140a through the objective lens 141. This field of view image is stored as a still image or a movie. The two regions surrounded by the dashed lines 140L and 140R are fields of view respectively determined by the rims of the glasses.

Also, within the visual fields surrounded by the dashed lines 140L and 140R shown in FIG. 8C there are a field of view N of a craftsman at the upper part and a field of view C of a craftsman at the lower part. The field of view N is a field of view in a line of sight when a craftsman is performing operations, and field of view 140C is a field of view in a line of sight connection when the craftsman is looking at guidance display of the display section 150 at the time of operations. In this way, when the craftsman performs operations, since the range of the field of view 140N is looked at they are not bothered by guidance display of the display section 150, and when looking at the guidance display the range of the field of view 140C is looked at and it is possible to see the appearance of a workbench to a certain extent. Specifically, although it is possible to see display due to the display section 150 in part of the field of view, the fact that the display section 150 does not completely cover the field of view is convenient.

Next, operations performed by a craftsman and guidance display using the display section 150 will be described using FIG. 9A to FIG. 9D. FIG. 9A shows the craftsman 450 wearing the wearable terminal 100, and shows a line of sight direction when performing operations and a line of sight direction when looking at guidance display of the display section 150. Specifically, when performing operations the line of sight direction is LS1, while when looking at the display section 150 the line of sight direction is LS2. The two line of sight directions are out of alignment by an angle θ.

Also, imaging range of the image input section 140a is a range shown by the dotted line, with the imaging direction SL1 as a center. The line of sight direction LS1 of the craftsman 450 and the imaging direction SL1 of the image input section 140a are the same direction which means that is possible for the image input section 140a to acquire images of places where the craftsman 450 is working.

FIG. 9B to FIG. 9D show appearance of coating glaze (or raw material/coloring material) on the product such as an accessory (jewelry) 500 on a workbench. FIG. 9B shows appearance when glaze (or raw material/coloring material) 503 is mixed in an indent of a pallet 52, and a spatula 501 is immersed in this glaze (or raw material/coloring material) that has been mixed. FIG. 9C shows appearance when a product such as an accessory (jewelry) 500 is attached to a holding device 504, and the product such as an accessory (jewelry) 500 is coated with the glaze (or raw material/coloring material) using the spatula 501.

In the state shown in FIG. 9B and FIG. 9C, the craftsman 450 is performing operations while looking directly through the field of view 140N (refer to FIG. 8C) without looking at the display section 150. During operation, if the craftsman 450 wants to look at the guidance display, they change the line of sight direction and they will see the display section 150. Appearance at this time is shown in FIG. 9D. Since images that should be used as an example are displayed on the display section 150, coating of glaze (or raw material/coloring material) on the product such as an accessory (jewelry) 500 is possible while looking at this guidance display.

Also, it is possible to determine at what location the craftsman 450 is performing operations, based on a positional relationship of the holding device 504 and the product such as an accessory (jewelry) 500. The product such as an accessory (jewelry) 500 has a projection provided at an appointed position, and this projection can be held using the holding device 504. Accordingly, it is possible to determine at what portion the craftsman 450 is performing operations by looking at the positional relationship between the holding device 504 and the spatula 501. This determination may be analysis of image data that has been acquired by the image input section 140a.

Next, operation processes that have been stored, from layer A to layer C, are shown using FIG. 10. The upper row of drawings in FIG. 10 show a layer A operation process to coat glaze (or raw material/coloring material) A, for example, at specific portions A of the product such as an accessory (jewelry) 500. Time T=T10 shows a work start point frame. At time T=Tt, the craftsman is performing coating of the glaze (or raw material/coloring material) at central portions of the product such as an accessory (jewelry) 500. During operations for this portion, if the craftsman has requested guidance display an operation example movie made up of models from a given time before time Tt is displayed on the display section 150. Obviously there may also be cases where there is intermediate coating of various colors, and in this case there are a plurality of glazes (or raw material/coloring materials). That is, to make it possible to clearly visualize operations and make retrieval easy, there may be cases where operations are sorted by some or all of by location, by glaze (or raw material/coloring material), by spatula and by time zone.

The middle row of drawings in FIG. 10 shows a layer B operation process of coating glaze (or raw material/coloring material) B on the product such as an accessory (jewelry) 500. At time T=Tr, the craftsman is performing coating of the glaze (or raw material/coloring material) at end portions of the product such as an accessory (jewelry) 500. During operations for this portion, if the craftsman has requested guidance display an operation sample movie made up of models from a given time before time Tr is displayed on the display section 150.

The lower row of drawings in FIG. 10 shows a layer C operation process of coating glaze (or raw material/coloring material) C on the product such as an accessory (jewelry) 500. At time T=Tc, the craftsman is performing coating of the glaze (or raw material/coloring material) at a specific location of the product such as an accessory (jewelry) 500. During operations for this portion, if the craftsman has requested guidance display an operation sample movie made up of models from a given time before time Tc is displayed on the display section 150.

In the operation processes from layer A to layer C, when performing guidance display, at the work start point frame (initial frame at the time of guidance display), material of the glaze (or raw material/coloring material) is displayed using a maker's model number, for example, and at the frame at Tt color may be displayed as a numerical value of a spectrophotometer. It should be noted that the work start point frame may be a time that is a given time before performing operations for the specified portion, and may be also be when an operation tool is at a specific position.

Also, as was described previously, regarding operating portion, this can be determined from a positional relationship between the holding device 504 and the spatula 501 based on image data that has been acquired using the image input section 140a.

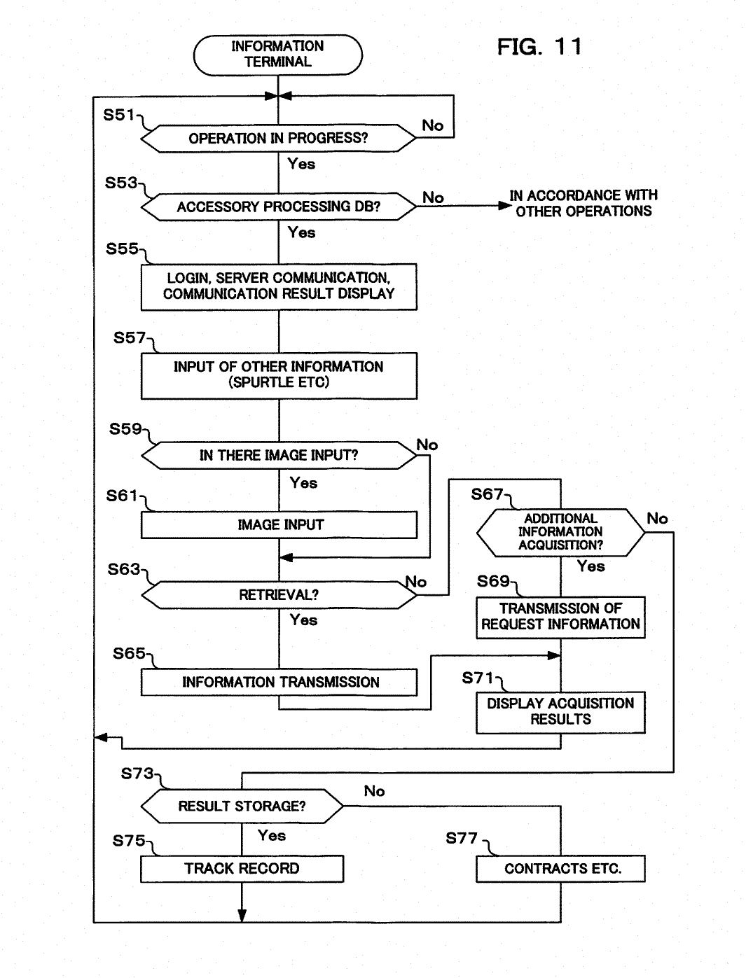

Next, operation of the storage system of this embodiment will be described using the flowcharts shown in FIG. 11 to FIG. 16.

The flowchart shown in FIG. 11 shows operation of the information terminal 300 used by a designer. This processing flow is executed by the CPU of the control section 310 within the information terminal 300 controlling each section within the information terminal 300 in accordance with programs stored in memory.

If the flow for the information terminal is commenced, it is first determined whether or not an operation is in progress (S51). Here, determination is based on whether or not operation members (for example, a keyboard, mouse, touch panel etc.) of the operating section 340 have been operated.

If the result of determination in step S51 is that an operation is in progress, it is determined whether or not it is product such as an accessory (jewelry) processing DB access mode (S53). In order for the designer to carry out product such as an accessory (jewelry) processing, in a case where the database within the server 200 will be accessed, the operating section 340 is operated and product such as an accessory (jewelry) processing DB access mode is set. Here it is determined whether or not this mode has been set. If the result of this determination is not a case where the product such as an accessory (jewelry) processing DB will be accessed, an operation that has been set by operating the operating section 340 is advanced to.

If the result of determination in step S53 is that the product such as an accessory (jewelry) processing DB will be accessed, login, server communication and communication results are displayed (S55). Here, login is performed in order to access the server 200, communication with the server 200 is performed, and whether or not an access was good or bad is displayed on the display section 350.

If it is possible to login and display communication results, next other information, for example, age and gender of the client, is input (S57). Here, the designer inputs information that will be required at the time of requesting from manufacturer, such as material and cost of the product such as an accessory (jewelry), as well as the client's age described above.

It is next determined whether or not there is an input image (S59). Here it is determined whether or not an image showing client's preferred shape and color, and color and shape of the base of the product such as an accessory (jewelry) etc. is being input at the time of the request for manufacture of a product such as an accessory (jewelry).

If the result of determination in step S59 is that there is image input, an image is input (S61). Here, an image is taken into the information terminal 300 using the information input section 360.

If the result of determination in step S61 is to input an image, or if the result of determination in step S59 is that there is no image input, it is next determined whether or not to perform retrieval (S63). In a case where the designer retrieves craftsmen that they will request to manufacture a product such as an accessory (jewelry), the operating section 340 is operated, and so determination is based on the operating state of this operating section 340.

If the result of determination in step S63 is retrieval, information is transmitted (S65). Here, information that was input in steps S57 and S61 is transmitted from the information terminal 300 to the server 200. If the server 200 receives this information, a plurality of products such as an accessory (jewelry) that are close to requested conditions are retrieved based on the received information.

On the other hand, if the result of determination in step S63 is not retrieval, it is determined whether or not additional information will be acquired (S67). In step S71, which will be described later, retrieval results are displayed, but in the event that these retrieval results are not sufficient, it is determined whether or not to further acquire additional information. This determination is based on operation of the operating section 340 by the designer.

If the result of determination in step S67 is to acquire additional information, request information is transmitted (S69). Here, request information such as information and display of next candidates for narrowing down the color of the product such as an accessory (jewelry) etc. is transmitted to the server 200.

If information has been transmitted in step S65, or if request information has been transmitted in step S69, acquisition results are displayed (S71). If the server 200 receives request information in step S65 or step S69, retrieval is carried out based on these items of information, and retrieval results are transmitted to the information terminal 300. In this step the retrieval results that have been received are displayed on the display section 350. At the time of display, it is made possible to compare and look at examples of products such as an accessory (jewelry) that are close to information that has been input, from among manufactured product such as an accessory (jewelry) results that are stored in the database 230 of the server 200. Once acquisition results have been displayed processing returns to step S51.

Returning to step S67, if the result of determination in this step is not acquisition of additional information, it is determined whether or not to store results (S73). If completed products such as an accessory (jewelry) are received and fitted to a client, results are stored. Here regarding the determination as to whether or not to perform this type of storage, determination is based on operation of the operating section 340 by a designer.

If the result of determination in step S73 is storage of results, the archival record is stored (S75). Here, images of completed products such as an accessory (jewelry), and information relating to images and craftsmen in a state where the product such as an accessory (jewelry) has been worn by the client, are stored in the storage section 330.

On the other hand, if the result of determination in step S73 is not results storage, processing for contracts etc. is performed (S77). In a case where a contract has been entered into between the designer and the operator of the server 200 regarding information transmission and information receipt, these items of processing are performed. Besides this, processing regarding product such as an accessory (jewelry) processing may also be performed.

If the archival record has been performed in step S75, or processing for contracts etc. has been performed, processing returns to step S51.

In this way, in the information terminal flow, when the designer requests manufacture of a product such as an accessory (jewelry), information on a product such as an accessory (jewelry) and color etc. for the client's preference is input (S57, S61). Based on this information, the server 200 retrieves examples of products such as an accessory (jewelry) that are close to the information that has been input, from among examples of products such as an accessory (jewelry) that have been manufactured that are stored in the database 230, and displays retrieval results (S71). At the time of display it is possible to compare and look at retrieval results. In requesting manufacture of a product such as an accessory (jewelry), the client's preference has a significant effect, and at the time of manufacture of a product such as an accessory (jewelry) there are personal taste and sensitivity requirements. Since it is possible to compare and look at a plurality of examples of products such as an accessory (jewelry), it is possible to submit a request to the most suitable craftsman.

Next, operation of the server 200 will be described using the flowchart shown in FIG. 12. This flowchart describes only operation that cooperates with the information terminal 300, and the flowchart shown in FIG. 14, which will be described later, describes only operation which cooperates with the wearable terminal 100. The flow shown in FIG. 12 and FIG. 14 is executed by the CPU of the control section 210 within the server 200 controlling each section within the server 200 in accordance with programs stored in memory.

If the server flow is commenced, it is first determined whether or not there is an access (S81). As described previously, when the designer retrieves craftsmen for product such as an accessory (jewelry) manufacture, access is made from the information terminal 300 to the server 200 (refer to S55 in FIG. 11). In this step, therefore, presence or absence of an access from the information terminal 300 is determined. If the result of determination is that there is not an access, a standby state is entered.

If the result of determination in step S81 is that there has been an access, it is determined whether or not access is permitted (S83). Here it is determined whether or not there is a person who has permission to access the server 200. If the result of this determination is that there is not a person with permission, a standby state is entered.

If the result of determination in step S83 is that there is a person with permission, next an initial screen is transmitted (S85). Here, an initial screen that includes product such as an accessory (jewelry) work association icons etc. is transmitted to the information terminal 300.

It is then determined whether or not a product such as an accessory (jewelry) related process will be performed at the information terminal in the (S87). In the event that the designer performs retrieval etc. from the information terminal 300 in order to request manufacture of a product such as an accessory (jewelry), an operation such as clicking on an icon for product such as an accessory (jewelry) work association on the initial screen is performed. In this step determination is based on information from the information terminal 300. If the result of this determination is not product such as an accessory (jewelry) work association, other services that have been set on the initial screen are executed.

If the result of determination in step S87 is product such as an accessory (jewelry) work association, it is determined whether or not there will be retrieval with image input (S89). When the designer retrieves craftsmen who will manufacture a product such as an accessory (jewelry), there are cases where images that show shape and color etc. are transmitted (refer to S61 to S65 in FIG. 11). In this step determination is based on what type of images have been transmitted for the purpose of retrieval from the information terminal 300.

If the result of determination in step S89 is that retrieval will be performed with image input, retrieval of the database (DB) is performed with images and information (S91). Here, retrieval within the database 230 is performed based on images that have been input from the information terminal 300, and information that has been associated with images and input. Specifically, products such as an accessory (jewelry) that are close to images and information that have been input (similar cases) are retrieved from among images of products such as an accessory (jewelry) that have been completed that are stored in the database 230, and information relating to these images.

Next, similar products are compared and displayed (S93). With the retrieval of step S91 a plurality of products that are close are retrieved, and here image data etc. is transmitted to the information terminal 300 so that it is possible to compare and display the similar products that have been retrieved. The information terminal 300 displays results once this data has been received (refer to S71 in FIG. 11). It should be noted that as a display method two or more cases may be displayed side-by-side, or they may be displayed sequentially upon instruction by the information terminal 300.

If comparison and display have been performed, it is next determined whether or not additional information has been requested (S95). As was described previously, in a case where a designer requests further acquisition of information at the information terminal 300, information in the request is transmitted (refer to S69 in FIG. 11). In this step it is determined whether or not additional information has been requested. If the result of this determination is that there is not an additional information request, processing returns to step S81.

If the result of determination in step S95 is that there is a request for additional information, information that has been selected is transmitted in accordance with results of the contract DB (S97). Here, information is searched in accordance with the additional information request, within a contractual range that has been stored in the contract DB 232 within the database 230, and transmitted to the information terminal 300. If the information terminal 300 receives information display is performed on the display section 350 (refer to S71 in FIG. 11). Once information is received processing returns to step S81

Returning to step S89, if the result of this determination is that retrieval will not be performed with image input, it is next determined whether or not to store with image input (S99). As was described previously, there are cases where storage is required for a completed accessory (jewelry) that has been received by a designer, a state fitted to a client, and craftsman information etc. (refer to S75 in FIG. 11). Here, determination is based on whether or not there is a storage request from the information terminal 300.

If the result of determination in step S99 is to perform storage, images are stored as manufactured examples and made into a database (DB) (S101). Here, images in state where a product such as an accessory (jewelry) has been worn by the client, and craftsman information etc., is stored in the database 230. Once storage has been performed processing returns to step S81.

On the other hand, if the result of determination in step S99 is not to perform storage, update of the contract DB etc. is performed (S103). Here, this is a case where determination in steps S89 and S99 is not applied, and other processing, for example, update of the contract DB, is performed. As update of the contract DB, privileges for cases such as when a craftsman grants permission to a third-party to browse images of products such as an accessory (jewelry) that they have manufactured themselves may be added in the contract DB, for example. If update of the contract DB etc. has been performed, processing returns to step S81.

In this way, in the server flow that cooperates with the information terminal, based on shape of an accessory preferred by the client, shape and design of associated accessory and clothing, color and shape of a base of a product such as an accessory (jewelry) etc. that have been transmitted from the wearable terminal 100, products such as accessories (jewelry) that are close to these items of information are retrieved (S89, S91). This means that it is possible for the designer to retrieve craftsmen that can manufacture the most suitable product such as an accessory (jewelry) for the client. Also, since images of product examples and craftsman information etc. are stored in the server 200 (S101), it is possible to simplify retrieval in the server 200.

Next, operation of the wearable terminal 100 will be described using the flowchart shown in FIG. 13. This flowchart is executed by the CPU of the control section 110 within the wearable terminal 100 controlling each section within the wearable terminal 100 in accordance with programs stored in memory.

If wearable terminal flow is commenced, it is first determined whether or not there has been an operation (S111). Here it is determined whether or not an operation member such as a power supply switch that is provided on the wearable terminal has been operated by a craftsman.

If the result of determination in step S111 is that there has been no operation, power supply is turned off at a given time (S131). Since it is common for the power supply battery of the wearable terminal 100 to be small, the power is turned off at a given time in order to prevent power wastage. If the power supply is turned off a sleep state is entered, and only the state of the power supply switch is monitored.

If the result of determination in step S111 is that there has been an operation, next an initial screen is displayed (S113). Here, an initial screen is displayed on the display section 150. On the initial screen it is possible to access the product such as an accessory (jewelry) processing DB (database 230), acquire information, and perform mode selection, such as to store images in the database DB.

If the initial screen has been displayed, it is next determined whether or not there is access to the product such as an accessory (jewelry) processing DB (S115). In cases such as where it is desired to access the database 230 and browse guidance images, a craftsman selects access to the product such as an accessory (jewelry) processing DB on the screen.

If the result of determination in step S115 is to access the product such as an accessory (jewelry) processing DB, login etc. is performed (S117). Here, ID and password for accessing the server 200 from the wearable terminal 100 are input, and login is performed.

It is next determined whether or not guidance information has been requested (S119). When the craftsman is performing manufacture of a product such as an accessory (jewelry), in a case where they want to browse guidance information such as guidance images and recipes, guidance information is requested to the server 200. As a request method, for example, speech may be input to the sound input section 143 of the information acquisition section 140 (refer to FIG. 8A), and a manual operation member may be provided. It should be noted that when it is possible to request and browse guidance information, a browsing related portion is subtracted from the privileges given to the craftsman.

If the result of determination in step S119 is that guidance information has been requested, guidance information is acquired (S121). Here, images for the current operation are retrieved from among images that are stored in the database of the server 200, and the guidance information that has been retrieved is acquired. Specifically, a product such as an accessory (jewelry) is manufactured with a similar pattern to a pattern that is currently in operation, and images and recipes etc. for performing operations for the same portions are acquired. This information that has been acquired is displayed on the display section 150 in step S141, which will described later (refer, for example, to FIG. 9D).

On the other hand, if the result of determination in step S119 is that there is not a request for guidance information, it is determined whether or not to upload information (S125). As was described previously (refer, for example, to FIG. 9A to FIG. 9D), with this embodiment guidance information such as guidance images is stored in the server 200, and it is possible for this guidance information to be disclosed to other craftsmen pursuant to contracts. In this step it is determined whether or not to store guidance images in the server 200. As a determination method, for example, determination may be performed based on speech that has been input to the sound input section 143 of the information acquisition section 140 (refer to FIG. 8A), and a manual operation member may be provided.

If the result of determination in step S125 is information upload, operating images are uploaded (S127). In steps S135 and S137, which will be described later, movies of operation in progress, images that have been taken by a color measurement camera, and color information, are acquired by the image input section 140a of the information acquisition section 140. In this step these items of information are transmitted to the server 200, and stored in the database 230. It should be noted that, as will be described later, this information is disclosed in a range that is acknowledged pursuant to contract.

Next, a privilege acquisition (addition) request etc. is performed (S129). Since provision of information such as guidance images is received from a craftsman, the server 200 provides that craftsman with privileges (refer to FIG. 7).

If privileges have been added in step S129, or if guidance information has been acquired step S121, it is next determined whether or not to return (S123). Here it is determined whether or not to return to the initial state. As a determination method, for example, determination may be performed based on speech that has been input to the sound input section 143 of the information acquisition section 140 (refer to FIG. 8A), and a manual operation member may be provided. If the result of this determination is not to return to the initial state, processing returns to step S119.

Returning to step S115, if the result of determination in this step is not product such as an accessory (jewelry) processing DB, it is determined whether or not to store processing images (S133). It is determined whether or not to store a movie during operations for manufacture of a product such as an accessory (jewelry). It should be noted that this movie is disclosed in a range of acknowledgment pursuant to contract (S119, S121).

If the result of determination in step S133 is to store processing images, movie shooting is performed and a movie is stored (S135). Here, a movie during operations to manufacture a product such as an accessory (jewelry) is acquired by the image input section 140a of the information acquisition section 140. As was described previously, this movie is transmitted to the server 200 in step S127, and stored in the database 230. Detailed operation of movie shooting and storage will be described later using FIG. 15.

Continuing on, if movie shooting is complete, shooting is performed with a digital camera (S137). Information including images that have been acquired by a device that can make a color a numerical value, such as a spectrophotometer, or a digital camera, etc. is transmitted to the server 200 and stored in the database 230. If shooting has been performed with the digital camera processing returns to step S111.

If the result of determination in step S133 is not processing image storage, it is determined whether or not there is guidance display (S139). As was described using FIG. 7 and FIG. 9D, in a case where a craftsman wants to reference operating state of another craftsman, a request for display of guidance images is issued to the server 200. In this step it is determined whether or not to perform display of guidance images. As a determination method, what operation there is may be determined from appearance of an operation that has been shot. Specifically, since there is a wearable device that shoots and stores a plurality of processes that are performed using fingertips of both hands and the eyes, it is possible to acquire taken images that correspond to fingertip positions of either the left or right hand of the operator from positions corresponding to the eyes of the operator of the process, and based on these imaging results it is possible to determine in which of the operator's hands and at what position tools and materials are being held. Since start time of a specific process is detected from a plurality of processes, this determination may be performed by this terminal if this information (images) is used, but it is also possible to provide a transmission section that transmits the imaging results to an external unit, and based on a first used tool or materials using either the left or right hand of the operator in the process, analogies to taken images corresponding to start time of operations are searched for in the external unit, and a receiving section that receives guidance information that has been retrieved using the results of analogy may be provided. There may be a display section for displaying the guidance information. That is, guidance is presented at the start of operation. Also, determination may be performed based on speech that has been input to the sound input section 143 of the information acquisition section 140 (refer to FIG. 8A), and a manual operation member may be provided.

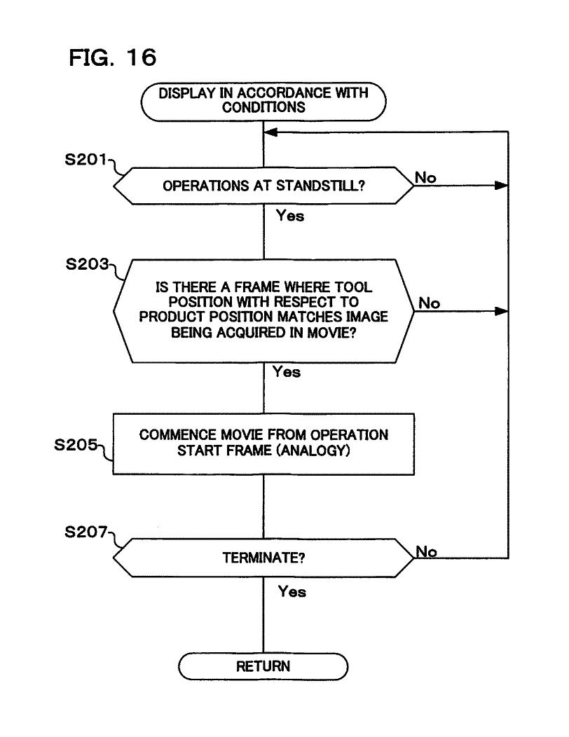

If the result of determination in step S139 is to perform guidance display, display is performed subject to conditions (S141). Here, guidance display is performed based on information that was acquired in step S121. Detailed operation of this display performed subject to conditions will be described later using FIG. 16.

On the other hand, if the result of determination in step S139 is not to perform guidance display, privileges from the designer requested (S143). Since a craftsman has referenced an operational video that was performed by another craftsman, a request is made via the server 200 so as to grant privileges for this other craftsman.

If display has been performed in step S141, or if privileges have been requested in step S143, processing returns to step S111.

In this way, in the processing flow for the wearable terminal, if a craftsman has permission a movie is taken during operations for manufacture of a product such as an accessory (jewelry) (S135), and information associated with the movie is stored in the database 230 of the server 200 (S125, S127). Also, in a case where a craftsman has referenced operations of another craftsman, if they have permission it is possible to reference a movie during operation that has been stored in the database 230 (S141). This means that it is possible to learn the skills of another craftsman, and is possible to utilize in skill improvement. Privileges are also granted to craftsmen who have supplied operational movies.

Next, operation of the server 200 will be described using the flowchart shown in FIG. 14. As was mentioned earlier, this flowchart only describes operation in cooperation with the wearable terminal 100. This flow shown in FIG. 14 is executed by the CPU of the control section 210 within the server 200 controlling each section within the server 200 in accordance with programs stored in memory.

If the server flow is commenced, it is first determined whether or not there is an access (S151). As was mentioned earlier, when a craftsman performs manufacturer of a product such as an accessory (jewelry), access is made from the wearable terminal 100 to the server 200 (refer to S117 in FIG. 13). In this step, therefore, presence or absence of an access from the wearable terminal 100 is determined. If the result of determination is that there is not an access, a standby state is entered.

If the result of determination in step S53 is that there has been an access, it is determined whether or not access is permitted (S153). Here it is determined whether or not there is a person who has permission to access the server 200. If the result of this determination is that there is not a person with permission, a standby state is entered.

If the result of determination in step S153 is that there is a person with permission, next an initial screen is transmitted (S155). Here, an initial screen that includes product such as an accessory (jewelry) work association icons etc. is transmitted to the wearable terminal 100.

Next, it is determined whether or not guidance information is being requested by the craftsman terminal (S157). As was described previously, there are cases where a craftsman requests guidance display (refer to S119 and S121 in FIG. 13). In this step determination is based on whether or not this request has been issued from the wearable terminal 100.

If the result of determination in step S157 is that a request for guidance information has been issued, in accordance with the contract DB information that has been retrieved is transmitted (S159). Here, within the database 230, information that has been requested is retrieved, within a range that is permitted pursuant to contracts stored in the contract DB 232. Once information has been retrieved, that information is transmitted to the wearable terminal 100. If the wearable terminal 100 has received the information, it is displayed on the display section 150 (refer to S141 FIG. 13).

On the other hand, if the result of determination in step S157 is that there is not a request for guidance information, it is determined whether or not to inputs and store craftsman terminal images (S161). As described previously, there are cases where it is permitted for a craftsman to store movies during operation or images of a product such as an accessory (jewelry) after completion in the database 230 (refer to S125, S127, S133, S135 and S137 in FIG. 13). Here, whether to input and store these images is determined based on signals from the wearable terminal 100. If the result of this determination is not to input and store images, other services are executed.

If the result of determination in step S161 is to input and store images, they are stored as a manufacturing DB and made into a database (S163). Here, information relating to images during operation and images of accessory (jewelry) that have been completed that have been input, and images relating to the craftsman, are stored in the database 230.

Next, granting of privileges is reflected in the contract DB (S165). The skills possessed by a craftsman are secret information, and it is generally considered that is it not desired to disclose this information to other people. Despite this, since there is cooperation in creating the database, privileges are granted and the craftsman is also given preferential treatment regarding the contract DB.

If information has been transmitted in step S159, or if privileges have been granted in step S165 and reflected in the contract DB, processing returns to step S151.

In this way, in the server flow in cooperation with the wearable terminal, if there is a request for display of guidance information from a craftsman, guidance information is transmitted pursuant to contracts (refer to S157 and S159). Also, if information such as images is transmitted from a craftsman, this information is made into a database (referred to S163). By creating this database, it is possible for the craftsman to browse guidance information that they require, and it is possible to utilize in skill improvement.

Next, operation for movie shooting and storage in step S135 will be described using the flowchart shown in FIG. 15. This flow is executed by the CPU of the control section 110 within the wearable terminal 100 controlling each section within the wearable terminal 100 in accordance with programs stored in memory.

If the flow for movie shooting and storage is commenced, it is first determined whether or not a speech command or the like has been issued (S171). In a case where a movie is taken and movie image data stored, a craftsman who is wearing the wearable terminal 100 instructs commencement of shooting of the movie using voice. Since both hands are often occupied during operation, being able to issue commands using voice is convenient. It should be noted that an operation section may be provided in the wearable terminal 100, and manual operations performed.

If the result of determination in step S171 is that there has been no speech command, power supply is turned off at a given time (S173). Since the power supply battery of the wearable terminal 100 us small, the power supply is turned off if a give time elapsed, in order to prevent power wastage, and a standby mode is entered.

If the result of determination in steps S171 is that a speech command has been issued, a camera is activated (S175). Here, the image input section 140a is activated and image data is acquired using the image sensor.

Once the camera has been activated, next operation is confirmed (S177). Here it is determined weather or not a craftsman is performing an operation to manufacture a product such as an accessory (jewelry). This determination is performed on the basis of image data has been acquired by the image input section 140a. If the result of determination in this step is that operation cannot be confirmed, processing returns to step S171.

Also, for operations that require such a high degree of specialization, there has also been progress with standardization of work environment, and a proper operation cannot be performed with improper arrangement of tools to be used and materials in front of a craftsman at the time of manufacture of a product. Accordingly, information on this type of operating environment can be a valuable operating determination. This is because quick workability is required such that even for the same workplace, operations are often performed with tools for each operation being prepared and arranged in advance, and from the field of view of the operator a tool is rapidly confirmed and picked up, or returned rapidly to a given position. That is, this type of state is determined using taken images at the time of operation, and determination of the operation based on the environment determination is extremely effective. For example, an image of this pallet entering the field of view (due to that pallet being prepared in front of the operator, or the operator facing in these directions) constitutes evidence of the fact that that operation performs coloring processing. Also, conditions such as determination of position of a fingertip and whether or not there is a tool and material for the position of the fingertip that has been determined from shape of a finger within a field of view (screen corresponding to field of view) are determined based on feature detection within the images.

That is, it is possible for this type of imaging system to shoot and store a plurality of processes that are performed using the fingertips of both hands and using the eyes. An imaging system, comprising: a control processor that detects start time of a specific process from plurality of processes, based on taken images corresponding to either left or right fingertip position of a worker performing the processes from position corresponding to the eyes of the worker, and a memory that stores the taken images, and taken images associated with respective processes within the plurality of processes, wherein the control processor detects which of a left or right hand of an operator is being used in the process, determines a first tool that is used, or material, using the hand that has been detected, detects operation start time in accordance with detection results for the used tool or material, and determines the taken images corresponding to the start time.

If it was possible to confirm operation in step S177, movie storage is performed (S179). Here, image data that has been acquired using the image input section 140a is temporarily stored in the storage section 130 within the wearable terminal 100. This movie storage is performed continuously until storage is interrupted in step S187, which will be described later. The movie that has been temporarily stored is transmitted as required to the server 200 in step S127 (refer to FIG. 13.

It is next determined whether or not there is operation for a specific portion (S181). Here, the object determination section 111 performs determination for operation location based on image data that has been acquired by the image input section 140a. As operating location, whether there is operation at the center of a product such as an accessory (jewelry), or operation at the edge of the product such as an accessory (jewelry), may be judged from a relative position relationship between positions of the product such as an accessory (jewelry) and a spatula. It may also be judged weather there is operation in progress for layer A, operation in progress for layer B, or operation in progress for later C. In this step it is determined at what specific location (which of a plurality of processes) operating location is at. It should be noted that when determining operation position determination may be based on sound data that has been input using the sound input section 143 as well as image data, and based on speech etc. of the craftsman etc.

If the result of determination in step S181 is that a specific location is being worked on, location information is stored (S183). If the craftsman displays guidance information, it is desirable to display images that correspond to the location being operated upon. As was described previously, the object determination section 111 determines which specific location is being operated on, in other words, determines which process among a plurality of processes is being performed. In this step, therefore, location information is stored in a movie being stored. This location information is stored in association with taken images. At the time of storage, information representing a process, such as location information, may be made into an index or metadata and stored.

On the other hand, if the result of determination in step S181 is that there is not operation of a specific location, it is determined whether or not there is no operation progress (S185). Here it is determined whether or not there is no progress in operation based on image data on a movie that was acquired using the image input section 140a.

If the result of determination in step S185 is that there is no progress in operation, storage is interrupted (S187). Since operation has been interrupted, storage of the movie that was commenced in step S179 is interrupted. Once storage has been interrupted processing returns to step S177. If it is possible to confirm that work is being performed in step S177, storage of the movie is started again in step S179.

If location information has been stored in step S183, or if the result of determination in step S185 is that there is progress in operation, it is next determined whether or not to terminate (S189). In the event that the flow for movie shooting and storage has been commenced by a speech command, it is terminated with a speech command. Flow for movie shooting and recording may also be terminated using a method other than this. If the result of determination in this step is that operation is not terminated, processing returns to step S177.

If the result of determination in step S189 is that movie storage is to be terminated, a file with a header is created (S191). Here a file with a header, made up of image data of a movie that was stored in step S179 and location information that was stored in step S183, is created. If the file with a header has been created, processing returns to step S171.

In this way, with the flow for movie shooting and recording, when storing a movie of work in progress for manufacturer of a product such as an accessory (jewelry), location information is also stored at the same time (S183). This means that when the craftsman displays guidance images it is possible to reference images in accordance with location where work is in progress. I

Next, operation in accordance with conditions in step S141 (refer to FIG. 13) will be described using the flowchart shown in FIG. 16. This flow is executed by the CPU of the control section 110 within the wearable terminal 100 controlling each section within the wearable terminal 100 in accordance with programs stored in memory.

If the flow for display in accordance with conditions is commenced, it is first determined whether or not operations are at a standstill (S201). In the event that the craftsman references guidance display, normally the display section 150 is being looked at and so operations are in a rest state. Whether or not operations are at a standstill is determined based on image data that was acquired using the image input section 140a. If the result of this determination is that operations are at a standstill, a standby state is entered.

If the result of determination in step S201 is that operations are at a standstill it is determined whether or not position of a tool with respect to position of a product is in a movie having a frame that coincides with an image being acquired (S203). It is judged at what position a tool, such as a spatula, is with respect to position of an accessory (jewelry), such as, for example, is the position of a spatula in the center, or at both edges. A frame that matches the determined position is then retrieved from within a movie of operations in progress that has been stored in the database (refer, for example, to FIG. 9D). If the result of this retrieval is that there is not a matching frame, processing returns to step S201.

If the result of determination in step S203 is that there is a matching frame, a movie is commenced from an operation start frame (analogy) (S205). Operation start frame is a time corresponding to, for example, T=T10, T20, T30 in FIG. 10, and is a frame a given time before commencement of operations at a specific location, or at a time when a working tool is in a specific positional relationship.

If playback of a movie has been started, it is next determined whether the playback is complete (S207). Here determination is based on whether or not play back of the movie has been completed. If the result of this determination is that the playback has not been completed, processing returns to step S201.

If the result of determination in step S207 is that playback is complete, this flow is terminated and the originating flow is returned to.

In this way, in the flow for display in accordance with conditions, if there is a frame of a movie that matches a specific location, movie playback is commenced from an operation start frame which is before this matching frame. As a result, with sudden playback from the specific location, it is possible to confirm an image from a preparation stage before the specific location is reached, and this is useful as guidance information.

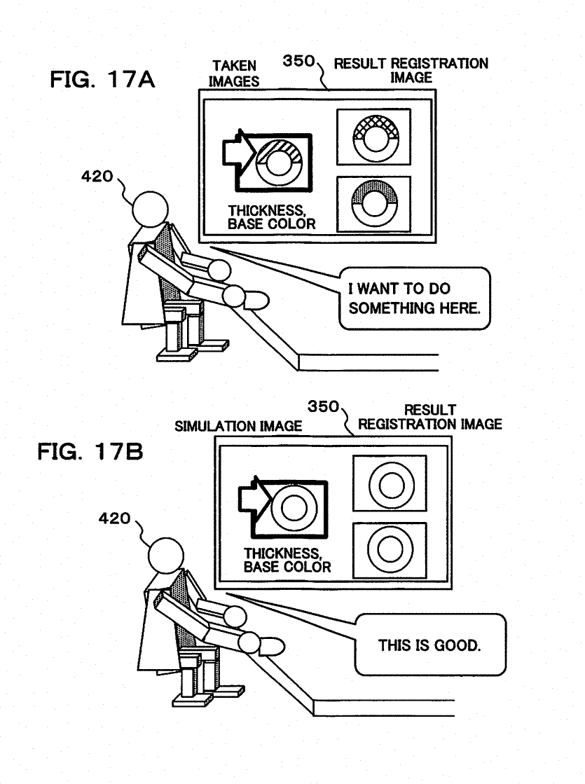

Next, searching for intended manufacturers of a product such as an accessory (jewelry) by the designer 420 using the information terminal 300 will be described using FIG. 17A and FIG. 17B.

FIG. 17A shows a product such as an accessory (jewelry) displayed on the display section 350 of the information terminal 300, and shows appearance of a designer 420 considering what color to make the product such as an accessory (jewelry). Taken images that have been taken of an accessory the client prefers are displayed on the left side of the display section 350. Information relating to thickness and base color of a product such as an accessory (jewelry) that the designer 420 has input is shown below a taken image.

Images that have been retrieved from among images stored in the database 230 (refer to S91 in FIG. 12) by accessing the server 200 and transmitting taken images (refer to S65 in FIG. 11), namely images that are close to taken images that have been transmitted, specifically images of a product such as an accessory (jewelry) that has been manufactured by a craftsman (result registration images), are displayed on the right side of the display section 350 (refer to S71 in FIG. 11).

However, in the event that the designer 420 (or client) is not satisfied with the result registration images, it is possible to generate simulation images such as shown in FIG. 9B based on the taken images. If the simulation images are transmitted to the server 200 (refer to S69 in FIG. 11), the server 200 again performs retrieval based on the simulation images (refer to S97 in FIG. 12), and the results of this retrieval are transmitted. The images that have been transmitted are displayed on the right side of the display section 350 in FIG. 17B as result registration images.

With a product that requires high degree of taste and sensitivity and a high degree of skill at the time of manufacture, such as a product such as an accessory (jewelry), it is difficult to get a product that meets the demands of the designer and the client. However, since it is possible to perform retrieval based on result registration images and also to retrieve again using images that have been corrected (simulation images), as with this embodiment, it is possible to obtain a product that meets expectations.

As has been described above, with the second embodiment also, similarly to the first embodiment, it is possible to provide an imaging system that divides a series of operations in time and shoots and stores as a plurality of processes. Since this imaging system has a process detection section that detects processes based on taken images (refer, for example, to the object determination section 111 in FIG. 5B), it becomes possible to divide a series of operations based on process detection results at the same time as shooting, and it is possible to store taken images and movie images in association with the processes. As a result, with this imaging system only movies for sections that it is desired to look at after completion of operations are retrieved, and reconfirmation can be performed easily, which is useful in skill transfer. It should be noted that a storage control section within the imaging system may store part of a movie that has been continuously taken with titles of separate operations attached to each movie, so as to make it easy to retrieve for every operation, and it may also be possible to store in a file format that has metadata for separate operations attached.

As has been described above, in each of the embodiments of the present invention, as examples of subtle operations that are performed while concentrating using hands and eyes, it is possible to shoot and store a plurality of processes for manufacturing a product that requires special attention with regard to color cast and shape (for example, a product such as an accessory (jewelry)). Specifically, location specific processes corresponding to location on a product are detected based on taken images (refer, for example, to S181 in FIG. 15), and taken images and taken images associated with location specific processes are stored (refer, for example, two S183 in FIG. 15). Since it becomes easy to retrieve taken images corresponding to location on a product, it is possible to perform appropriate direction in accordance with processing location and state of advancement etc. of a product such as a product such as an accessory (jewelry). While description has been given for work that requires a refined sensitivity, particularly visually and in terms of sense of touch, the same also applies to work that requires others of the five senses. However, operations that require skill with regard to sight (color cast and shape), and touch (feel and shape) have been described as examples that utilize image data. With operations that utilize a sense of taste, a sense of smell and a sense of hearing also, if dedicated sensors are used it goes without saying that it is possible to use the same storage and creation of evidence. Also, organs that detect sense of taste, sense of hearing and sense of smell are concentrated on a person's face, and it is also effective when providing such sensors in a glasses-type terminal. Also, in the case of performing operations that utilize a work person's sense of taste, hearing and smell, since operations are performed after locating a physical object, information on images obtained from a glasses-type terminal (or wearable terminal that is similar to a glasses-type terminal) constitutes useful operation associated information.

Also, with each of the embodiments of the present invention, a plurality of processes for manufacturing a product are shot (refer, for example, to S135 in FIG. 13, and S179 in FIG. 15), location specific processes corresponding to location on the product are detected based on taken images (refer, for example, to S181 in FIG. 15), taken images and location specific process are associated with each other (refer, for example, to S183 in FIG. 15), taken images for which association has been performed are transmitted to an external device (refer, for example, to S127 in FIG. 13), and taken images that have been retrieved by the external device are received (refer, for example, to S121 in FIG. 13). Guidance display is performed based on taken images that have been received (for example, S141 in FIG. 13).

Therefore, in each of the embodiments of the present invention, it is possible to perform guidance display in accordance with location on a product, and it is possible to perform appropriate direction in accordance with processing location state of progress of a product such as a product such as an accessory (jewelry). Generally, with operations that are difficult and require a high degree of skill, evidence is retained in a form broken down into separate processes. With of each of the embodiments of the present invention, using a wearable terminal images that are close to position of the eyes of the operator are utilized, and it is possible to observe appearance of an operator's visual check, and movement of fingers and fingertips in a field of view that is close to the gaze of the operator, and so it is possible to perform accurate determinations. Obviously it is also possible to use information of an external camera, as required. Also, isolation for each process is determined using settings that are performed in respective processes, finger movement, how a tool is being held etc., and so no burden is imposed on the operator. In the case of shooting and storing a plurality of processes, a process detection section is provided that detects processes based on taken images and sounds specific to that operation, and other information, and results of detection by this process detection section are made into evidence and made into metadata, and it is possible to store taken images and the processes in association with each other. Also, if a format is provided for which retrieval is easy and confirmation is also easy (for example, an image file with metadata), it is possible to retrieve only these crucial parts under various conditions (made into a report, used as a guide), and on the operators gaze, and that can be confirmed.

Also, the system of each of the embodiments of the present invention has a database 230 that manages process (image) information for a plurality of craftsmen and craftsman product images, a target image acquisition section (retrieval section 211) that acquires target images of a product from an information terminal 300, a retrieval section 211 that retrieves product images from target images, and a guidance section 213 that acquires further process images. It is possible to select a craftsman by comparing target images and workmanship images of model objects from a plurality of craftsmen from representative color information of at least two places on product images, and transition information of the representative color information of two places. Specifically, an image management server is provided to collect images of products made by a craftsman, and in order for a designer to manufacture a product such as an accessory (jewelry), if photographs of jewelry are sent from the image management server it is possible to retrieve the most suitable craftsman for manufacture of a product such as an accessory (jewelry). Images representing processing techniques are uploaded to a server, and guidance display is presented to a craftsman who has been evaluated highly using these images.

It should be noted that in each of the embodiments of the present invention description has been given for a product such as an accessory (jewelry) as a product. However the product is not limited to a product such as an accessory (jewelry), and the present invention can be applied to any manufactured object that requires a high degree of skill. Further, example embodiments consistent with the present invention may be used to repair (not necessary manufacture) an existing workpiece or even a living organism. With each of the embodiments of the present invention description has been given with operations of a craftsman as an example that is easy to describe (for which it is comparatively easy to imagine a manufactured item, use of tools and materials), but this is not limiting, and the present invention can be applied widely to units, devices, and methods for monitoring and storing operational processes that perform operations using a specific tool or material, or that base material. The present invention is not limited to a craftsman, and from cosmetic relationships to constructional relationships, and further in various fields of examination, analysis, repair, and medicine, in obtaining deliverables obtained by means of highly specialized operations, and further results of troubleshooting and treatment etc., there is a demand for a high degree of skill including personal preferences and sensitivity aspects. Also, since there are operations having extremely high dependency on human skills, it is desirable to visualize appropriate operations and techniques for each process in accordance with progress of operations, as with each of the embodiments of the present invention. That is, in the sense of skill transfer also, there is a need of technology for confirmation of operational quality and for suitable observation and storage for which operational processes can be understood. That is, if an operation is clearly visualized and easy to retrieve, it is easy to reconfirm that process, and easy to retain as evidence, and it can also be used in an archive for skill transfer. As should be appreciated from the foregoing, in addition to an artisan manufacturing jewelry, example embodiments consistent with the present invention may be used in many other contexts, such as, for example, a surgical procedure having multiple steps (e.g., cutting skin, removing interior tissue, cauterizing, internal suturing, attaching an implant or prosthetic, final suturing, etc.) using one or more hands, one or more hand tools (e.g., scalpel, sponge, needle, etc.), raw materials (e.g., sutures, units of blood, prosthetics, etc.) etc. Other example embodiments consistent with the present invention may be used in the context of a mechanic, technician, electrician, plumber, etc., performing a diagnostic and/or repair procedure having multiple steps. Yet other example embodiments consistent with the present invention, may be used in the context of training personal to perform a multi-step procedure (e.g., using hand tools), or guiding a multi-step procedure in an emergency (e.g., in the case of a natural disaster, an accident, on the battlefield, etc.). As noted above, some multistep procedures may involve equipment which may require proper settings. Guidance information may include such setting information. The multi-step procedures will normally involve one or more hand tools, and may involve the use of raw materials and ancillary equipment. The term “workpiece” is intended to cover a newly manufactured product, a product to be repaired, a product to be diagnosed, a living organism, etc.

Also, with each of the embodiments of the present invention, a wearable terminal 100 used by a craftsman and an information terminal 300 used by a designer are linked by a network. However, a plurality of craftsmen may be linked via a network such as an intranet, and only guidance display performed. A plurality of designers may also be linked by a network, images of products such as an accessory (jewelry) that have been completed and associated information stored on the server, and only retrieval of craftsman performed.

Also, with each of the embodiments of the present invention, various items to be stored in the database 230 have been described, but besides these items, for example, it is also possible to further add information such as in progress process information (a number of processes information, for example, three times, or six times), material information, delivery information, price information, etc., as options.

Also, with the embodiments of the present invention, the object determination section 111, operation determination section 112 and display control section 113 within the control section 110 of the wearable terminal 100, the retrieval section 211, display control section 212, guidance section 213 and information regulation section 213a within the control section 210 of the server 200, and the operation determination section 311 and the display control section 312 within the control section 310 of the information terminal 300, have been realized using CPUs and programs, but may be constructed separately from these control sections, and may be implemented using hardware or software. It is also possible for these sections to have a hardware structure such as gate circuits generated based on a programming language that is described using Verilog, and also to use a hardware structure that utilizes software such as a DSP (digital signal processor). Suitable combinations of these approaches may also be used.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they be downloaded via the Internet.

Also, with the one embodiment of the present invention, operation of this embodiment was described using flowcharts, but procedures and order may be changed, some steps may be omitted, steps may be added, and further the specific processing content within each step may be altered. It is also possible to suitably combine structural elements from different embodiments.

Also, regarding the operation flow in the patent claims, the specification and the drawings, for the sake of convenience description has been given using words representing sequence, such as “first” and “next”, but at places where it is not particularly described, this does not mean that implementation must be in this order.

As understood by those having ordinary skill in the art, as used in this application, ‘section,’ ‘unit,’ ‘component,’ ‘element,’ ‘module,’ ‘device,’ ‘member,’ ‘mechanism,’ ‘apparatus,’ ‘machine,’ or ‘system’ may be implemented as circuitry, such as integrated circuits, application specific circuits (“ASICs”), field programmable logic arrays (“FPLAs”), etc., and/or software implemented on a processor, such as a microprocessor.

The present invention is not limited to these embodiments, and structural elements may be modified in actual implementation within the scope of the gist of the embodiments. It is also possible form various inventions by suitably combining the plurality structural elements disclosed in the above described embodiments. For example, it is possible to omit some of the structural elements shown in the embodiments. It is also possible to suitably combine structural elements from different embodiments.

What is claimed is:

1. An imaging system for shooting, from a point of view of an operator, and storing, a multi-step process performed using fingers of both left and right hands of the operator and eyes of the operator, the imaging system comprising:
a wearable image sensor that captures images corresponding to the point of view of the operator, wherein the captured images are associated with the multi-step process;
a memory that stores the captured images; and
a processor that
1) processes the captured images to determine an operation start time of at least one of the steps of the multi-step process using at least one of (A) first use a hand tool in the captured images, (B) first use of a hand tool by a specific one of the left and right hand of the operator in the captured images, (C) first use of material in the captured images, (D) a position of a hand tool relative to a workpiece in the captured images, (E) a position of the workpiece contacted by a hand tool in the captured images, (F) a position of a hand tool within a field of view of the captured images, (G) a position of a first hand tool relative to a second hand tool in the captured images, (H) a first appearance of some combination of a first hand tool, a second hand tool, a raw material and a workpiece in the captured images, and
2) indexes the captured images stored in the memory based on the determined operation start time.

2. The imaging system of claim 1 wherein the processor processes the captured images to determine the operation start time by
(i) detecting which of the left or right hand of the operator is being used,
(ii) determine a first used tool or material that is used by the detected left or right hand of the operator, and
(iii) determines the operation start time in accordance with the determined first used tool or material.

3. The imaging system of claim 1, further comprising:
a process specific database, wherein a step of the process of the taken images corresponding to the operation start time is determined by analogical inference based on information from the process specific database and the first used tool or material.

4. The imaging system of claim 1, further comprising:
a display that displays the taken images, wherein
the processor uses the index to commence display of guidance information on the display from the determined operation start point.

5. The imaging system of claim 1, wherein the multi-step process is manufacturing of a product, and
wherein the processor, at the time of the manufacture of the product, determines an arrangement of hand tools and materials used in the manufacture from the point of view of the operator based on the taken images, and determines the step of the multi-step process based the determined arrangement.

6. An imaging device, comprising:
an image sensor that captures images of a plurality of steps of a manual manufacturing process for manufacturing a product;
a processor that detects a location-specific step of the manual manufacturing process based on a portion of the product being worked on in the captured images that have been acquired by the image sensor, and associates the captured images and the location-specific step of the manual manufacturing process; and
a communication circuit that transmits the captured images that have been subjected to association by the processor to an external device, and receives captured images that have been retrieved by the external device.

7. The imaging device of claim 6, wherein:
the communication circuit further transmits information relating to a location of the portion of the product that has been detected by the processor to the external device, and receives captured images associated with a location that have been retrieved by the external device.

8. The imaging device of claim 6, further comprising:
a display, for displaying captured images that have been retrieved by the external device, when retrieval of captured images of a specific location of a portion of the product has been requested to the external device.

9. An imaging method, for capturing and storing steps of a manual manufacturing processes for manufacturing a product, the imaging method comprising:
capturing images of the plurality of steps of the manual manufacturing process for manufacturing the product;
detecting a location-specific step of the manual manufacturing process based on a portion of the product being worked on in the captured images;
associating the captured images and the location-specific step of the manual manufacturing process; and
storing captured images in association with the location-specific step of the manual manufacturing process.

10. The imaging method of claim 9, further comprising:
determining frames of the captured images that correspond to a start point of a step by analogical inference, based on a first appearance of a particular tool or material that is used in the multi-step manual manufacturing process.

11. The imaging method of claim 10, further comprising:
displaying the step from the determined start point.

12. The imaging method of claim 9, wherein:
at the time of manufacture of the product, the location on the product is determined by image determination of a second used tool within the taken images.

13. An imaging method, comprising:
shooting a plurality of steps of a manual manufacturing process for manufacturing a product;
detecting a location specific step of the manual manufacturing process based on a portion of the product being worked on in the captured images;
associating the captured images and the location-specific step of the manual manufacturing process;
transmitting the captured images that have been subjected to association to an external device; and
receiving captured images that have been retrieved by the external device.

14. The imaging method of claim 13, further comprising:
transmitting information relating to a location of the portion of the product that has been detected to the external device; and
receiving captured images associated with a location that have been retrieved by the external device.

15. The imaging method of claim 13, further comprising:
displaying captured images that have been retrieved by the external device, when retrieval of captured images of a specific location of a portion of the product has been requested to the external device.

16. A system for shooting, from the point of view of an operator, and storing, a multi-step process performed using fingers of both left and right hands of the operator, and eyes of the operator, the system comprising:
a wearable image sensor for capturing images that correspond to finger tip positions of either a left hand or right hand of the operator, from the point of view of the operator;
a transmission circuit that transmits imaging results from the image sensor to an external unit in order to determine a start time of a specific step of the multi-step process, based on the imaging results;
a reception circuit that receives guidance information that has been retrieved using the determined start time of the specific step by analogical inference, based on a first used tool or material that is employed using either the left hand or the right hand of the operator; and
a display that displays the guidance information.
